(19) United States
(12) Patent Application Publication
(10) Pub. No.: US 2014/0067704 A1
(43) Pub. Date: Mar. 6, 2014

(54) JOB BROADCAST DATA PUBLICATION THROUGH A WORK-OPPORTUNITY LISTING SERVER USING A RADIAL ALGORITHM TO AUTOMATICALLY DISTRIBUTE THE JOB BROADCAST DATA IN A THRESHOLD RADIAL DISTANCE FROM A SET OF GEOSPATIAL COORDINATES ASSOCIATED WITH A MOBILE DEVICE

(71) Applicant: Raj V. Abhyanker, Cupertino, CA (US)

(72) Inventor: Raj V. Abhyanker, Cupertino, CA (US)

(21) Appl. No.: 14/079,611

(22) Filed: Nov. 13, 2013

Related U.S. Application Data
(63) Continuation-in-part of application No. 13/236,964, filed on Sep. 20, 2011.
Application No. 13/236,964 is a continuation-in-part of application No. 13/242,303, filed on Sep. 23, 2011.
Application No. 13/242,303 is a continuation-in-part of application No. 13/242,303, filed on Sep. 23, 2011.
(60) Provisional application No. 61/894,443, filed on Oct. 23, 2013.

(51) Int. Cl. G06Q 10/10; H04W 64/00

(52) U.S. Cl. CPC G06Q 10/1053; H04W 64/00
USPC 705/321

(57) ABSTRACT

Disclosed are a method, a device and a system of job broadcast data publication through a work-opportunity listing server using a radial algorithm to automatically distribute the job broadcast data in a threshold radial distance from a set of geospatial coordinates associated with a mobile device. In one embodiment, the job broadcast data is radially distributed as a notification data through an on-page posting, an electronic communication, and/or a push notification delivered to (1) a set of recipients 114 through an internet protocol (IP) based network associated with users and/or their user profiles around an epicenter defined at a set of geospatial coordinates associated with the job broadcast data generated through a computing device or (2) a set of service providers through a cellular network using the radial algorithm in addition to the set of recipients 114 through the IP based network associated with users and/or their user profiles.

### CLAIMS OF PRIORITY

This patent application is a continuation in part and claims priority from:

(1) U.S. Utility patent application Ser. No. 13/236,964 titled ‘NEAR-FIELD COMMUNICATION ENABLED WEARABLE APPAREL GARMENT AND METHOD TO CAPTURE GEOSPATIALLY AND SOCIALLY RELEVANT DATA OF A WEARER OF THE WEARABLE APPAREL GARMENT AND/OR A USER OF A READER DEVICE ASSOCIATED THEREWITH’ filed on Sep. 20, 2011.
(2) U.S. Utility patent application Ser. No. 13/242,303 titled ‘GEOSPATIALLY CONSTRAINED GASTRONOMIC BIDDING’ filed on Sep. 23, 2011.
(3) U.S. Utility patent application Ser. No. 13/272,245 titled ‘NEAR-FIELD COMMUNICATION ENABLED WEARABLE APPAREL GARMENT AND METHOD TO CAPTURE GEOSPATIALLY AND SOCIALLY RELEVANT DATA OF A WEARER OF THE WEARABLE APPAREL GARMENT AND/OR A USER OF A READER DEVICE ASSOCIATED THEREWITH’ filed on Oct. 13, 2011.
(4) U.S. Provisional Patent Application No. 61/894,443 titled ‘RADIO BROADCAST, COMMERCE PUSHPINS, AND AUTOMATED PAGE UPDATES TO A GEOSPATIALLY CONSTRAINED NEIGHBORHOOD REGION THROUGH AN INTERNET NETWORK AND SEPARATELY A TRACKABLE SOCIAL COMMUNITY FORMED BASED ON TRACKABLE TAG BASED APPAREL THAT CREATES INCENTIVES AND CONNECTIONS BETWEEN USERS WEARING PROMOTIONAL APPAREL AND THOSE OTHER USERS READING THE TRACKABLE TAG ON THE APPAREL’ filed on Oct. 23, 2013.

### FIELD OF TECHNOLOGY

This disclosure relates generally to data processing devices and, more particularly, to a method, a device and/or a system of job broadcast data publication through a work-opportunity listing server using a radial algorithm to automatically distribute the job broadcast data in a threshold radial distance from a set of geospatial coordinates associated with a mobile device, according to one embodiment.

### BACKGROUND

An employer (e.g., an organization, a non-profit institution, a home owner, a tenant, a manager) may post a work opportunity (e.g., a job listing, a task, a career opportunity) on a job search engine (e.g., LinkedIn.com, TaskRabbit mobile application, Monster.com, Dice.com, etc.). The employer may receive applications from candidates responding to the work opportunity through the job search engine. The employer may be inundated with applications from active candidates who may not be ideally suited for the work opportunity because they live too far away and/or lack desired skills.

In some cases, a preferred applicant may already be employed and may not be searching for jobs through the job search engine. The preferred applicant may be unaware of the work opportunity as a result of their lack of participation through the job search engine. Therefore, the preferred applicant may never discover an option to apply for the work opportunity even when the work opportunity is in a location geographically proximate to an address where the preferred candidate has a non-transitory association (e.g., an existing home address, an existing work address).

Sometimes, the preferred applicant may wish to pursue the work opportunity despite being already employed when the work opportunity is presented to them because of geospatial proximity of the work opportunity to the non-transitory location(s) associated with the preferred candidate. Because the preferred candidate may never be presented with the work opportunity, the employer may not have a chance to interview and/or hire the preferred candidate. Therefore, the employer may waste money in hiring, training and ultimately failing with a suboptimal candidate (e.g., a candidate who lives too far away and/or lacks desired skills)

### SUMMARY

Disclosed are a method, a device and a system of job broadcast data publication through a work-opportunity listing server using a radial algorithm to automatically distribute the job broadcast data in a threshold radial distance from a set of geospatial coordinates associated with a mobile device.

In one aspect, a method of a work-opportunity listing server includes validating that a job broadcast data generated through a mobile device is associated with a verified user of the work-opportunity listing server using a processor and a memory. The method verifies that a set of geospatial coordinates associated with the job broadcast data generated through the mobile device are trusted based on a claimed geospatial location of the verified user of the work-opportunity listing server. In addition, the method determines that a time stamp associated with a creation date and a creation time of the job broadcast data generated through the mobile device is trusted based on the claimed geospatial location of the verified user of the work-opportunity listing server.

Furthermore, the job broadcast data generated through the mobile device is automatically published on a set of user profiles having associated verified addresses in a threshold radial distance from the set of geospatial coordinates associated with the job broadcast data generated through the mobile device of the verified user of the work opportunity listing server using a radial algorithm. A listing criteria associated with the job broadcast data including a description, a photograph, a video, a salary, a fixed fee amount, a category, and a functional status of a job offered through the job broadcast data may be processed. The job may be a household job, a repair job, a maintenance job, a professional job and/or a career opportunity. An availability chart may be populated when the job associated with the listing criteria is posted. The availability chart may include a target candidate living area radius, a start timing, an hours per day, an hours per month, a professional qualification criteria and/or a timing criteria. The method may determine that the broadcast data is generated by the verified user of the neighborhood broadcast system when validating that the broadcast data is associated with the mobile device.

The method may determine that an application on the mobile device is communicating the broadcast data to the neighborhood broadcasting system when the broadcast data is processed. The verified user may be associated with a verified user profile in the neighborhood broadcasting system through the application on the mobile device. The job broadcast data generated through the mobile device may be presented as a job alert pushpin of the job broadcast in a geospatial map surrounding pre-populated residential and/or business listings in a surrounding vicinity (such that the job alert pushpin of the job broadcast may be automatically presented on the geospatial map in addition to being presented on the set of user profiles having associated verified addresses in the threshold radial distance from the set of geospatial coordinates associated with the job broadcast data generated through the mobile device of the verified user of the work-opportunity listing server).

The job broadcast data generated through the mobile device may be radially distributed through an on-page posting, an electronic communication, and/or a push notification (delivered to desktop and/or mobile devices). The job broadcast data may be associated with users and/or their user profiles around an epicenter 144 defined at the set of geospatial coordinates associated with the job broadcast data. The job broadcast data may be generated through the mobile device to all subscribed user profiles in a circular geo-fenced area defined by the threshold distance from the set of geospatial coordinates associated with the job broadcast data. Furthermore, the job broadcast data may be generated through the mobile device through the radial algorithm of a neighborhood broadcasting system that measures a distance away of each address associated with each user profile from the current geospatial location at the epicenter.

The verified user may be permitted to drag and/or drop the job alert pushpin on any location on the geospatial map, and/or automatically determine a latitude and/or a longitude associated with a placed location. A career center, a hardware store, a professional services provider, a landscaper, a gardener, a plumber, a handyman, and/or a homeless shelter in a surrounding geospatial area to the set of geospatial coordinates associated with the job broadcast data generated through the mobile device may be automatically notified. The geospatial coordinates may be extracted from a metadata associated with the job broadcast data generated through the mobile device when verifying that the set of geospatial coordinates associated with the job broadcast data generated through the mobile device are trusted based on the claimed geospatial location of the verified user of the work-opportunity listing server. A relative match between a persistent clock associated with the work-opportunity listing server and/or a digital clock of the mobile device may determine that the time stamp associated with the creation date and/or time of the job broadcast data generated through the mobile device is accurate and therefore trusted.

A publishing of the job broadcast data generated through the mobile device on a set of user profiles having associated verified addresses in the threshold radial distance from the set of geospatial coordinates associated with the job broadcast data generated through the mobile device of the verified user of the work-opportunity listing server may be automatically deleted based on a job alert expiration time. A set of residential addresses each associated with a resident name in a neighborhood surrounding the mobile device may be geocoded. The method may prepopulate the set of residential addresses (each associated with the resident name) as the set of user profiles in the threshold radial distance from the claimed geospatial location of the verified user of the work-opportunity listing server in a neighborhood curation system communicatively coupled with the work-opportunity listing server. The method may permit the verified user to modify content in each of the set of user profiles. The modified content may be tracked through the neighborhood curation system.

A reversible history journal associated with each of the set of user profiles such that a modification of the verified user can be undone on a modified user profile page may be generated. An editing credibility of the verified user based on an edit history of the verified user and/or a community contribution validation of the verified user by other users of the neighborhood curation system may be determined. The job broadcast data generated through the mobile device to a set of user profiles having associated verified addresses in a threshold radial distance from the claimed geospatial location of the verified user of the work-opportunity listing server using the radial algorithm may be automatically published. A claim request of the verified user generating the job broadcast data generated through the mobile device through the mobile device to be associated with an address of the neighborhood curation system may be processed.

It may be determined if the claimable neighborhood in the neighborhood curation system is associated with a private neighborhood community in the claimable neighborhood of the neighborhood curation system. The verified user may be associated with the private neighborhood community in the claimable neighborhood of the neighborhood curation system if the private neighborhood community has been activated by the verified user and/or a different verified user. The verified user may be permitted to draw a set of boundary lines in a form of a geospatial polygon such that the claimable neighborhood in a geospatial region surrounding the claim request creates the private neighborhood community in the neighborhood curation system if the private neighborhood community may be inactive.

The method may verify the claim request of the verified user generating the job broadcast data generated through the mobile device through the mobile device to be associated with a neighborhood address of the neighborhood curation system when the address may be determined to be associated with a work address and/or a residential address of the verified user. The job broadcast data generated through the mobile device on the private neighborhood community associated with the verified user generating the job broadcast data generated through the mobile device may be simultaneously published through the mobile device in the threshold radial distance from the address associated with the claim request of the verified user of the neighborhood curation system (when automatically publishing the job broadcast data generated through the mobile device on a set of user profiles having associated verified addresses) in a threshold radial distance from the claimed geospatial location of the verified user of the work-opportunity listing server based on a set of preferences of the verified user using the radial algorithm.

A set of resumes may be automatically downloaded to the mobile device (an employer may be the verified user). An interface may be provided to the employer such that the employer can use a haptic ‘flick’ gesture in a horizontal and/or a vertical fashion to switch a viewing pane associated with a resume. A response of the employer being at least one of a dismiss, a save, a rating, a review and/or an interview of an applicant for the job associated with the job broadcast data through the work-opportunity listing server may be analyzed. A video communication and/or an audio communication between the mobile device of the employer and/or another mobile device of the potential job applicant may be automatically initiated through the work-opportunity listing server based on the interview of the applicant for the job associated with the job broadcast data through the work-opportunity listing server.

The job applicant and/or other job applicants may be permitted to view the rating and/or the review provided by the employer for each of the potential job applicants based on a participation criteria set by the employer and/or the job applicant, such that each job applicant may be able to view ratings and/or reviews of each participating candidate for the job associated with the job broadcast data. Each job applicant for the job associated with the job broadcast data may be permitted to communicate with each other. Each job applicant may form social connections with each other based on the participation criteria set by the employer and/or the job applicant (such that each job applicant may be able to form social connections with each participating candidate for the job associated with the job broadcast data). Participating employers in the work-opportunity listing server may be permitted to see previous ratings, interview comments, reviews, prescreen questions, and/or background checks of across a plurality of applicants applying for a plurality jobs through the work-opportunity listing server such that different employers benefit from previous diligence of at one of previous ratings, interview comments, reviews, prescreen questions, and/or background checks by participating employers with each applicant to the job that has previously applied for different jobs through the work-opportunity listing server.

A summary data may be provided to the employer generating the job broadcast data generated through the mobile device through the mobile device of how many user profile pages were updated with an alert of the job broadcast data generated through the mobile device when publishing the job broadcast data generated through the mobile device in the private neighborhood community and/or the set of user profiles having associated verified addresses (in the threshold radial distance from the claimed geospatial location of the verified user of the work-opportunity listing server) based on the set of preferences of the verified user.

The job broadcast data generated through the mobile device may be live broadcasted to the different verified user and/or other verified users in the private neighborhood community and/or currently within the threshold radial distance from the current geospatial location through the work-opportunity listing server through a multicast algorithm such that a live broadcast multicasts to a plurality of data processing systems associated with each of the different user and/or the other verified users simultaneously when the mobile device of the verified user generating the live-broadcast enables broadcasting of the job broadcast data generated through the mobile device to any one of a geospatial vicinity around the mobile device of the verified user generating the broadcast and/or any private neighborhood community in which the verified user has a non-transitory connection.

The different verified user and/or other verified users in the private neighborhood community may be permitted to bi-directionally communicate with the verified user generating the broadcast through the work-opportunity listing server. Any private neighborhood community in which the verified user has a non-transitory connection may be a residential address of the verified user and/or a work address of the verified user that has been confirmed by the work-opportunity listing server as being associated with the verified user. The threshold distance may be between 0.2 and/or 0.4 miles from the set of geospatial coordinates associated with the job broadcast data generated through the mobile device to optimize a relevancy of the live-broadcast.

The work-opportunity listing server may include a crowdsourced moderation algorithm in which multiple neighbors to a geospatial area determine what content contributed to the work-opportunity listing server persists and/or which may be deleted. The work-opportunity listing server may permit users to mute messages of specific verified users to prevent misuse of the work-opportunity listing server. All subscribed user profiles in a circular geo-fenced area may be defined by the threshold distance from the set of geospatial coordinates associated with the job broadcast data generated through the computing device through the radial algorithm of a neighborhood broadcasting system that measures a distance away of each address associated with each user profile from the current geospatial location at the epicenter 144.

In another aspect, a method of a work-opportunity listing server includes determining that a time stamp associated with a creation date and/or a creation time of a job broadcast data generated through a computing device is trusted based on a claimed geospatial location of a user of the work-opportunity listing server using a processor and a memory. The method includes automatically publishing the job broadcast data generated through the computing device on a set of user profiles having associated verified addresses in a threshold radial distance from a set of geospatial coordinates associated with the job broadcast data generated through the computing device of the user of the work-opportunity listing server using a radial algorithm.

In addition, the method includes radially distributing the job broadcast data as a notification data through an on-page posting, an electronic communication, and/or a push notification delivered to either (1) a set of recipients 114 through an internet protocol (IP) based network associated with users and/or their user profiles around an epicenter 144 defined at the set of geospatial coordinates associated with the job broadcast data generated through the computing device or (2) a set of service providers accessible by the work opportunity server through a cellular network using the radial algorithm in addition to the set of recipients 114 through the IP based network associated with users and/or their user profiles.

In yet another aspect, a system includes a work opportunity server to automatically publish a job broadcast data on a set of user profiles having associated verified addresses in a threshold radial distance from a set of geospatial coordinates associated with the job broadcast data of a verified user of the work-opportunity listing server using a radial algorithm. The system also includes a mobile device communicatively coupled with the work opportunity server through a network to generate the job broadcast data using a camera, a microphone, and/or a sensory capability of the mobile device to generate a captured data that is appended with a present geospatial location and/or a time stamp associated with a creation date and/or a creation time of the captured data in generating the job broadcast data.

A validation module may determine that a job broadcast data generated through a mobile device may be associated with a verified user of the work-opportunity listing server using a processor and/or a memory, and/or to determine that the broadcast data may be generated by the verified user of the neighborhood broadcast system when validating that the broadcast data may be associated with the mobile device. A validation module may ensure that a set of geospatial coordinates associated with the job broadcast data generated through the mobile device are trusted based on a claimed geospatial location of the verified user of the work-opportunity listing server.

A time stamp module 202 may determine that a time stamp associated with a creation date and/or a creation time of the job broadcast data generated through the mobile device may be trusted based on the claimed geospatial location of the verified user of the work-opportunity listing server. A listing module may determine a listing criteria associated with the job broadcast data including a description, a photograph, a video, a salary, a fixed fee amount, a category, a functional status of a job offered through the job broadcast data, wherein the job may be a household job, a repair job, a maintenance job, a professional job and/or a career opportunity.

A charting module may populate an availability chart when the job associated with the listing criteria may be posted, wherein the availability chart includes a target candidate living area radius, a start timing, an hours per day, an hours per month, a professional qualification criteria and/or a timing criteria. An application module may communicate the broadcast data to the neighborhood broadcasting system when the broadcast data may be processed, and/or to associate the verified user with a verified user profile in the neighborhood broadcasting system through the application on the mobile device.

A pushpin module may present the job broadcast data generated through the mobile device as a job alert pushpin of the job broadcast in a geospatial map surrounding pre-populated residential and/or business listings in a surrounding vicinity, such that the job alert pushpin of the job broadcast may be automatically presented on the geospatial map in addition to being presented on the set of user profiles having associated verified addresses in the threshold radial distance from the set of geospatial coordinates associated with the job broadcast data generated through the mobile device of the verified user of the work-opportunity listing server.

A radial distribution module may radially distribute the job broadcast data generated through the mobile device through an on-page posting, an electronic communication, and/or a push notification delivered to desktop and/or mobile devices associated with users and/or their user profiles around an epicenter 144 defined at the set of geospatial coordinates associated with the job broadcast data generated through the mobile device to all subscribed user profiles in a circular geo-fenced area defined by the threshold distance from the set of geospatial coordinates associated with the job broadcast data generated through the mobile device through the radial algorithm of a neighborhood broadcasting system that measures a distance away of each address associated with each user profile from the current geospatial location at the epicenter 144. A placement module may enable the verified user to drag and/or drop the job alert pushpin on any location on the geospatial map, and/or automatically determining a latitude and/or a longitude associated a placed location.

A notification module may automatically notify a career center, a hardware store, a professional services provider, a landscaper, a gardener, a plumber, a handyman, and/or a homeless shelter in a surrounding geospatial area to the set of geospatial coordinates associated with the job broadcast data generated through the mobile device. An extraction module may separate the geospatial coordinates from a metadata associated with the job broadcast data generated through the mobile device when verifying that the set of geospatial coordinates associated with the job broadcast data generated through the mobile device are trusted based on the claimed geospatial location of the verified user of the work-opportunity listing server.

A matching module may determine a relative match between a persistent clock associated with the work-opportunity listing server and/or a digital clock of the mobile device to determine that the time stamp associated with the creation date and/or time of the job broadcast data generated through the mobile device may be accurate and therefore trusted. A deletion module may automatically remove a publishing the job broadcast data generated through the mobile device on a set of user profiles having associated verified addresses in the threshold radial distance from the set of geospatial coordinates associated with the job broadcast data generated through the mobile device of the verified user of the work-opportunity listing server based on a job alert expiration time. A plotting module may geocode a set of residential addresses each associated with a resident name in a neighborhood surrounding the mobile device.

A data-seeding module may prepopulate the set of residential addresses each associated with the resident name as the set of user profiles in the threshold radial distance from the claimed geospatial location of the verified user of the work-opportunity listing server in a neighborhood curation system communicatively coupled with the work-opportunity listing server. A modification module may alter content in each of the sets of user profiles. A discovery module may track the modified content through the neighborhood curation system. An undo module may generate a reversible history journal associated with each of the set of user profiles such that a modification of the verified user can be undone on a modified user profile page. A reputation module may determine an editing credibility of the verified user based on an edit history of the verified user and/or a community contribution validation of the verified user by other users of the neighborhood curation system.

A publishing module may automatically communicate the job broadcast data generated through the mobile device to a set of user profiles having associated verified addresses in a threshold radial distance from the claimed geospatial location of the verified user of the work-opportunity listing server using the radial algorithm. A claiming module may process a claim request of the verified user generating the job broadcast data generated through the mobile device through the mobile device to be associated with an address of the neighborhood curation system. A private-neighborhood module may determine if the claimable neighborhood in the neighborhood curation system may be associated with a private neighborhood community in the claimable neighborhood of the neighborhood curation system.

An association module may associate the verified user with the private neighborhood community in the claimable neighborhood of the neighborhood curation system if the private neighborhood community has been activated by the verified user and/or a different verified user. A boundary module may permit the verified user to draw a set of boundary lines in a form of a geospatial polygon such that the claimable neighborhood in a geospatial region surrounding the claim request creates the private neighborhood community in the neighborhood curation system if the private neighborhood community may be inactive. An address type module may verify the claim request of the verified user generating the job broadcast data generated through the mobile device through the mobile device to be associated with a neighborhood address of the neighborhood curation system when the address may be determined to be associated with a work address and/or a residential address of the verified user.

A concurrency module may simultaneously publish the job broadcast data generated through the mobile device on the private neighborhood community associated with the verified user generating the job broadcast data generated through the mobile device through the mobile device in the threshold radial distance from the address associated with the claim request of the verified user of the neighborhood curation system when automatically publishing the job broadcast data generated through the mobile device on a set of user profiles having associated verified addresses in a threshold radial distance from the claimed geospatial location of the verified user of the work-opportunity listing server based on a set of preferences of the verified user using the radial algorithm.

A download module may automatically download a set of resumes to the mobile device, wherein an employer may be the verified user, and/or to provide an interface to the employer such that the employer can use a haptic ‘flick’ gesture in a horizontal and/or a vertical fashion to switch a viewing pane associated with a resume. The employer module may analyze a response of the employer being at least one of a dismiss, a save, a rating, a review and/or an interview of an applicant for the job associated with the job broadcast data through the work-opportunity listing server. The employer module may automatically initiate a video communication and/or an audio communication between the mobile device of the employer and/or another mobile device of the potential job applicant through the work-opportunity listing server based on the interview of the applicant for the job associated with the job broadcast data through the work-opportunity listing server.

An applicant module may permit the job applicant and/or other job applicants to view the rating and/or the review provided by the employer for each of the potential job applicants based on a participation criteria set by the employer and/or the job applicant, such that each job applicant may be able to view ratings and/or reviews of each participating candidate for the job associated with the job broadcast data, and/or to permit each job applicant for the job associated with the job broadcast data to communicate with each other and/or form social connections with each other based on the participation criteria set by the employer and/or the job applicant, such that each job applicant may be able to form social connections with each participating candidate for the job associated with the job broadcast data.

A historical applicant module may permit participating employers in the work-opportunity listing server to see previous ratings, interview comments, reviews, prescreen questions, and/or background checks of across a plurality of applicants applying for a plurality of jobs through the work-opportunity listing server such that different employers benefit from previous diligence of at one of previous ratings, interview comments, reviews, prescreen questions, and/or background checks by participating employers with each applicant to the job that has previously applied for different jobs through the work-opportunity listing server. A summary module may generate a summary data to the employer generating the job broadcast data generated through the mobile device through the mobile device of how many user profile pages were updated with an alert of the job broadcast data generated through the mobile device when publishing the job broadcast data generated through the mobile device in the private neighborhood community and/or the set of user profiles having associated verified addresses in the threshold radial distance from the claimed geospatial location of the verified user of the work-opportunity listing server based on the set of preferences of the verified user.

A live broadcast module may live broadcast the job broadcast data generated through the mobile device to the different verified user and/or other verified users in the private neighborhood community and/or currently within the threshold radial distance from the current geospatial location through the work-opportunity listing server through a multicast algorithm such that a live broadcast multicasts to a plurality of data processing systems associated with each of the different user and/or the other verified users simultaneously when the mobile device of the verified user generating the live-broadcast enables broadcasting of the job broadcast data generated through the mobile device to any one of a geospatial vicinity around the mobile device of the verified user generating the broadcast and/or in any private neighborhood community in which the verified user has a non-transitory connection.

A bi-directional communication module may permit the different verified user and/or other verified users in the private neighborhood community to bi-directionally communicate with the verified user generating the broadcast through the work-opportunity listing server. A moderation module may apply a crowdsourced moderation algorithm in which multiple neighbors to a geospatial area determine what content contributed to the work-opportunity listing server persists and/or which may be deleted. A muting module may permit users to mute messages of specific verified users to prevent misuse of the work-opportunity listing server. A threshold module may automatically set the threshold distance between 0.2 and/or 0.4 miles from the set of geospatial coordinates associated with the job broadcast data generated through the mobile device to optimize a relevancy of the live-broadcast. A non-transitory module may determine any private neighborhood community in which the verified user has a non-transitory connection may be a residential address of the verified user and/or a work address of the verified user that has been confirmed by the work-opportunity listing server as being associated with the verified user.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a network view of a job opportunity server having a radial distribution module communicating with a device that generates a radial broadcast through an internet protocol network using a radial algorithm of the radial distribution module of the job opportunity server, according to one embodiment.

FIG. 2 is an exploded view of the radial distribution module of FIG. 1 that applies the radial algorithm, according to one embodiment.

FIG. 3 is a broadcast view that demonstrates how the radial distribution module of FIG. 1 is used to communicate a job opportunity broadcast data to claimed user profiles, pre-seeded user profiles, and to telephone devices through a heterogeneous network formed through the internet protocol network of FIG. 1 and through a cellular network, according to one embodiment.

FIG. 4 is a radial operation view that illustrates an expansion of a threshold radial distance based on a claimed neighborhood at a radial boundary surrounding an epicenter formed by geo spatial coordinates of the device of FIG. 1, according to one embodiment.

FIG. 5 illustrates a remote association view in which a mobile device of an employer receives the job broadcast data of FIG. 3 based on a non-transitory claimed address associated with a profile of the employer even when the employer's mobile device is outside a threshold radial distance of a broadcast, according to one embodiment.

FIG. 6 is an employer view that explains how the employer of FIG. 5 manages and communicates with a set of applicants based on the job broadcast data, according to one embodiment.

FIG. 7 is a job broadcast view that explains how a broadcasting user creates a broadcast and manages notifications in neighborhoods that they have claimed, according to one embodiment.

FIG. 8 is a user interface view that explains how a user drags pushspins to a map including a broadcast pushpin, which is different than other pushpins in that a time and a location of the broadcast pushpin is fixed based on a set of geospatial coordinates associated with a mobile device of the broadcasting user of FIG. 7, according to one embodiment.

FIG. 9 is a process flow of radially distributing the job broadcast data of FIG. 3 as a notification data around an epicenter defined at the set of geospatial coordinates of FIG. 8 associated with the job broadcast data, according to one embodiment.

FIG. 10 is a table view illustrating data relationships between users, locations, and with a set of notification types needed to generate a broadcast, according to one embodiment.

FIG. 11 is a critical path view illustrating a flow based on time in which critical operations in establishing a bi-directional session between a verified user and those individuals receiving the job broadcast data of FIG. 3 is established, according to one embodiment.

Other features of the present embodiments will be apparent from the accompanying drawings and from the detailed description that follows.

### DETAILED DESCRIPTION

Example embodiments, as described below, may be used to provide a method, a system and/or a device of job broadcast data publication through a work-opportunity listing server using a radial algorithm to automatically distribute the job broadcast data in a threshold radial distance from a set of geospatial coordinates associated with a mobile device. Although the present embodiments have been described with reference to specific example embodiments, it will be evident that various modifications and changes may be made to these embodiments without departing from the broader spirit and scope of the various embodiments.

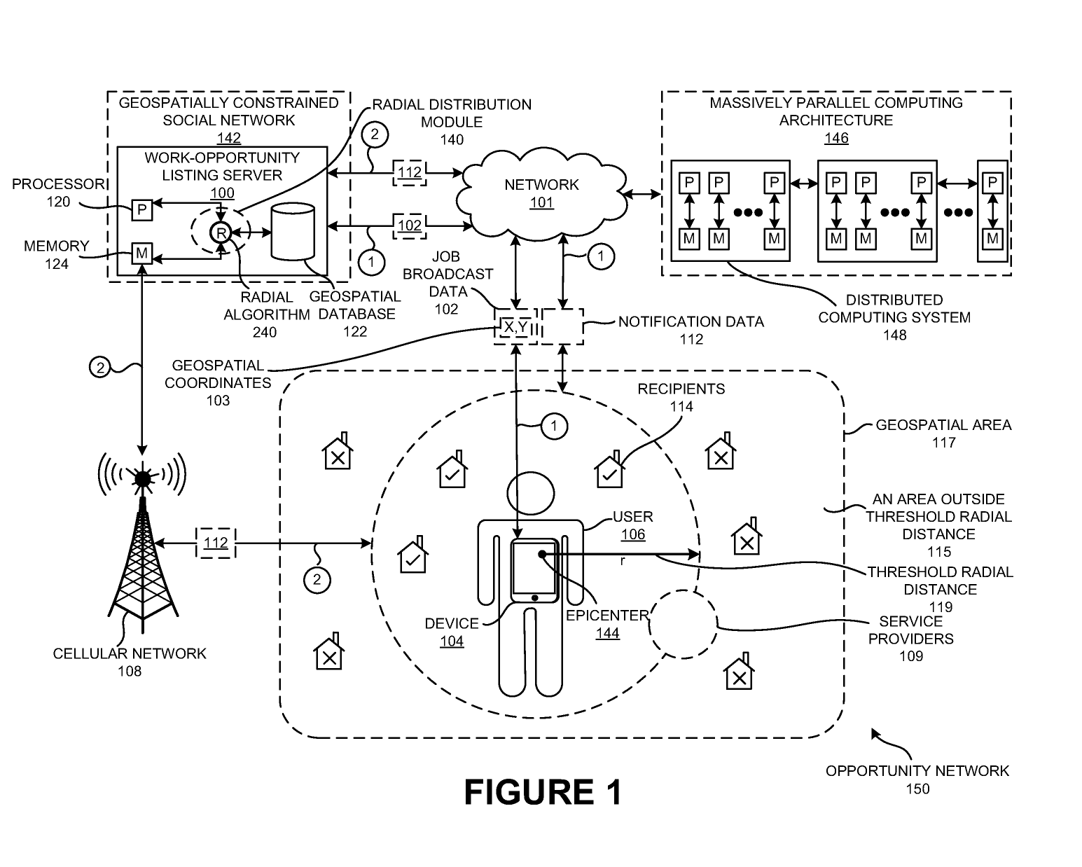

FIG. 1 is a network view of a job opportunity server having a radial distribution module communicating with a device that generates a radial broadcast through an internet protocol network using a radial algorithm of the radial distribution module of the job opportunity server, according to one embodiment.

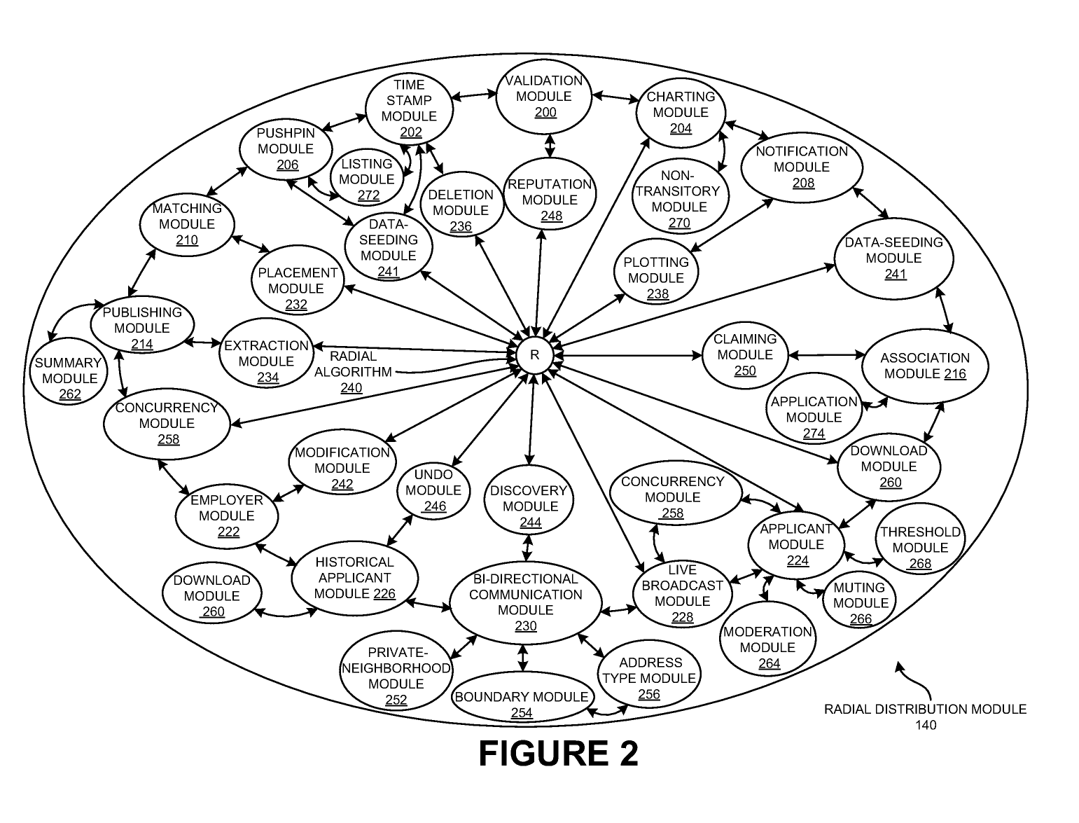

Particularly, FIG. 1 illustrates an opportunity network 150, according to one embodiment. The embodiment of FIG. 1 describes a work-opportunity listing server 100, a network 101, a job broadcast data 102, a set of geospatial coordinates 103, a device 104 (e.g., a mobile device 504), a user 106, a cellular network 108, service providers 109 (including a career center 309A, a hardware store 309B, a professional service provider 309C, a landscaper 309D, a gardener 309E, a plumber 309F, a handyman 309G, and a homeless shelter 309H), a notification data 112, a set of recipients 114, an area outside the threshold radial distance 115, a geospatial area 117, a threshold radial distance 119, a processor 120, a geospatial database 122, a memory 124, a radial distribution module 140 (e.g., that applies a radial algorithm 240 of FIG. 2 using a series of modules working in concert as described in FIG. 2), a geospatially constrained social network 142, an epicenter 144, a massively parallel computing architecture 146, and a distributed computing system 148.

The work-opportunity listing server 100 includes a processor 120, a memory 124, and a geospatial database 122, according to the embodiment of FIG. 1. The work-opportunity listing server 100 may be one or more server side data processing systems (e.g., web servers operating in concert with each other) that operate in a manner that provide a set of instructions to any number of client side devices (e.g., the device 104 (e.g., a mobile device 504)) communicatively coupled with the work-opportunity listing server 100 through the network 101. For example, the work-opportunity listing server 100 may be a computing system (e.g., or a group of computing systems) that operates in a larger client-server database framework (e.g., such as in a social networking software such as Nextdoor.com, Fatdoor.com, Facebook.com, etc.).

The device 104 (e.g., a mobile device 504) (e.g., a smartphone, a tablet, a laptop) may access the work-opportunity listing server 100 through the network 101 using a browser application of the mobile device (e.g., Google® Chrome) and/or through a client-side application downloaded to the device 104 (e.g., a mobile device 504) (e.g., a Nextdoor.com mobile application, a Fatdoor.com mobile application) operated by the user 106. In an alternate embodiment, a non-mobile computing device, such as a desktop computer (not shown) may access the work-opportunity listing server 100 through the network 101.

The job broadcast data 102 may be communicated from the device 104 (e.g., a mobile device 504) to the work-opportunity listing server 100 through the network 101. The job broadcast data 102 may include information about a work opportunity (e.g., a job opportunity) offered by the user 106 to recipients 114 and/or the service providers 109 through the network 101. For example, the work opportunity may relate to a paid position of regular employment offered by the user 106 and/or a task, a casual/occasional work offered by the user 106 to the recipients 114 and/or the service providers 109.

The job broadcast data 102 may be generated and distributed through an application of the radial distribution module 140 (e.g., that applies the radial algorithm 240 of FIG. 2 using a series of modules working in concert as described in FIG. 2) of the work-opportunity listing server 100. The radial distribution module 140 (e.g., that applies the radial algorithm 240 of FIG. 2 using a series of modules working in concert as described in FIG. 2) may be a series of software functions/processes that simulates the experience of transmitting and receiving local broadcasts for the verified user, according to one embodiment.

Using an internet protocol based network (e.g., the network 101), the work-opportunity listing server 100 may be able to use the radial distribution module 140 (e.g., that applies the radial algorithm 240 of FIG. 2 using a series of modules working in concert as described in FIG. 2) to simulate a radio frequency (RF) based communication network using an IP network topology of the network 101. Therefore, the job broadcast data 102 can be distributed using the work-opportunity listing server 100 to a geo-constrained area (e.g., the recipients 114 in the geospatial area 117 and/or the service providers 109 in a geo-constrained area around an area in which the device 104 (e.g., a mobile device 504) operates without requiring expensive broadcast towers, transceivers, transmitters, amplifiers, antennas, tuners and/or wave generating and interpreting hardware (e.g., as may be required in local ham radio communication, frequency modulation (FM) audio systems, etc.). The radial distribution module 140 (e.g., that applies the radial algorithm 240 of FIG. 2 using a series of modules working in concert as described in FIG. 2) may recreate an experience of communication between parties in a geospatially restricted area (e.g., for example in the same city, in the surrounding neighborhood, in the same zip code, in the same building, in the same claimed neighborhood) through the use of an Internet protocol network. The work-opportunity listing server 100 may overcome technical challenges of determining a user's geospatial location, calculating distance to other verified users based on relative geospatial locations, and/or coordinating information with a database of geo-coded information of interest (e.g., using the geospatial database 122) using the radial distribution module 140 (e.g., that applies the radial algorithm 240 of FIG. 2 using a series of modules working in concert as described in FIG. 2).

The radial distribution module 140 (e.g., that applies the radial algorithm 240 of FIG. 2 using a series of modules working in concert as described in FIG. 2), as a function/module of the work opportunity server, may determine the location of the user 106, the distance between the user 106 and other verified users, and the distance between the user 106 and locations of interest. With that information, the radial distribution module 140 (e.g., that applies the radial algorithm 240 of FIG. 2 using a series of modules working in concert as described in FIG. 2) may further determine which verified users are within a predetermined vicinity of a user 106. This set of verified users within the vicinity of another verified user may then be determined to be receptive to broadcasts transmitted by the user 106 and to be available as transmitters of broadcasts to the user 106.

The radial distribution module 140 (e.g., that applies the radial algorithm 240 of FIG. 2 using a series of modules working in concert as described in FIG. 2) in effect may create a link between verified users of the network 101 that allows the users to communicate with each other, and this link may be based on the physical distance between the users as measured relative to a current geospatial location of the device 104 (e.g., a mobile device 504) with a claimed and verified (e.g., through a verification mechanism such as a postcard verification, a utility bill verification, and/or a vouching of the user with other users) non-transitory location (e.g., a home location, a work location) of the user and/or other users. In an alternate embodiment, the transitory location of the user (e.g., their current location, a current location of their vehicle and/or mobile phone) and/or the other users may also be used by the radial algorithm to determine an appropriate threshold distance for broadcasting a message.

Furthermore, the radial distribution module 140 (e.g., that applies the radial algorithm 240 of FIG. 2 using a series of modules working in concert as described in FIG. 2) may automatically update a set of pages associated with profiles of individuals and/or businesses that have not yet joined the network based on preseeded address information. In effect, the radial distribution module 140 (e.g., that applies the radial algorithm 240 of FIG. 2 using a series of modules working in concert as described in FIG. 2) may update preseeded pages in a geo-constrained radial distance from where a broadcast originates (e.g., using an epicenter 144 calculated from the current location of the device 104 (e.g., a mobile device 504)) with information about the job broadcast data 102. In effect, through this methodology, the radial distribution module 140 (e.g., that applies the radial algorithm 240 of FIG. 2 using a series of modules working in concert as described in FIG. 2) may leave ‘inboxes’ and/or post ‘alerts’ on pages created for users that have not yet signed up based on a confirmed address of the users through a public and/or a private data source (e.g., from Infogroup®, from a white page directory, etc.).

The radial distribution module 140 (e.g., that applies the radial algorithm 240 of FIG. 2 using a series of modules working in concert as described in FIG. 2) of the work-opportunity listing server 100 may be different from previous implementations because it is the first implementation to simulate the experience of local radio transmission between individuals using the internet and non-radio network technology by basing their network broadcast range on the proximity of verified users to one another, according to one embodiment.

FIG. 1 illustrates a number of operations between the device 104 and the recipients 114 and/or the service providers 109. Particularly, circle ‘1’ of FIG. 1 illustrates that the user of the device 104 communicates the job broadcast data 102 to the work-opportunity listing server 100 using the network 101. Then, after applying the radial algorithm 240 utilizing the radial distribution module 140, the work-opportunity listing server 100 generates and communicates an appropriate notification data (e.g., the notification data 112) associated with the job broadcast data 102 to a geospatially distributed set of recipients 114 in a radial area (radius represented as ‘r’ of FIG. 1) in a geospatial vicinity from an epicenter 144 associated a present geospatial location with the device 104 as illustrated as circle ‘2’ in FIG. 1.

The radial algorithm 240 may operate as follows, according to one embodiment. The radial algorithm may utilize a radial distribution function (e.g., a pair correlation function)

g(r)

in the opportunity network 150. The radial distribution function may describe how density varies as a function of distance from a user 106, according to one embodiment.

If a given user 106 is taken to be at the origin O (e.g., the epicenter 144), and if

ρ=/VN

is the average number density of recipients 114 in the opportunity network 150, then the local time-averaged density at a distance r from O is

ρg(r)

according to one embodiment. This simplified definition may hold for a homogeneous and isotropic type of recipients 114, according to one embodiment of the radial algorithm 240.

A more anisotropic distribution (e.g., exhibiting properties with different values when measured in different directions) of the recipients 114 will be described below, according to one embodiment of the radial algorithm 240. In simplest terms it may be a measure of the probability of finding a recipient at a distance of r away from a given user 106, relative to that for an ideal distribution scenario, according to one embodiment. The anisotropic algorithm involves determining how many recipients 114 are within a distance of r and r+dr away from the user 106, according to one embodiment. The radial algorithm 240 may be determined by calculating the distance between all user pairs and binning them into a user histogram, according to one embodiment.

The histogram may then be normalized with respect to an ideal user at the origin o, where user histograms are completely uncorrelated, according to one embodiment. For three dimensions (e.g., such as a building representation in the geospatially constrained social network 142 in which there are multiple residents in each floor), this normalization may be the number density of the system multiplied by the volume of the spherical shell, which mathematically can be expressed as

g₍r)=4πr²ρdr,

where ρ may be the user density, according to one embodiment of the radial algorithm 240.

The radial distribution function of the radial algorithm 240 can be computed either via computer simulation methods like the Monte Carlo method, or via the Ornstein-Zernike equation, using approximative closure relations like the Percus-Yevick approximation or the Hypernetted Chain Theory, according to one embodiment

This may be important because by confining the broadcast reach of a verified user in the opportunity network 150 to a specified range, the radial distribution module 140 (e.g., that applies the radial algorithm 240 of FIG. 2 using a series of modules working in concert as described in FIG. 2) may replicate the experience of local radio broadcasting and enable verified users to communicate information to their immediate neighbors as well as receive information from their immediate neighbors in areas that they care about, according to one embodiment. Such methodologies can be complemented with hyperlocal advertising targeted to potential users of the work-opportunity listing server 100 on preseeded profile pages and/or active user pages of the work-opportunity listing server 100. Advertisement communications thus may become highly specialized and localized resulting in an increase in their value and interest to the local verified users of the network through the work-opportunity listing server 100.

The radial distribution module 140 (e.g., that applies the radial algorithm 240 of FIG. 2 using a series of modules working in concert as described in FIG. 2) may solve the problem of trying to locate a receptive audience to a verified user's broadcasts, whether that broadcast may be one's personal music, an advertisement for a car for sale, a solicitation for a new employee, and/or a recommendation for a good restaurant in the area. This radial distribution module 140 (e.g., that applies the radial algorithm 240 of FIG. 2 using a series of modules working in concert as described in FIG. 2) may eliminate unnecessarily broadcasting that information to those who are not receptive to it, both as a transmitter and as a recipient of the broadcast. The radial algorithm saves both time and effort of every user involved by transmitting information only to areas that a user cares about, according to one embodiment.

In effect, the radial algorithm of the work opportunity server enables users to notify people around locations that are cared about (e.g., around where they live, work, and/or where they are physically located). In one embodiment, the user 106 can be provided ‘feedback’ after the job broadcast data 102 may be delivered to the recipients 114 and/or to the service providers 109 using the radial distribution module 140 (e.g., that applies the radial algorithm 240 of FIG. 2 using a series of modules working in concert as described in FIG. 2) of the work-opportunity listing server 100. For example, after the job broadcast data 102 may be delivered, the device 104 (e.g., a mobile device 504) may display a message saying: “3256 neighbors around a 1 radius from you have been notified on their profile pages of your gardening job notification in Menlo Park” and/or “8356 neighbors around a 1 radius from you have been notified of your full time job opportunity at your restaurant.”

The various embodiments described herein of the work-opportunity listing server 100 using the radial distribution module 140 (e.g., that applies the radial algorithm 240 of FIG. 2 using a series of modules working in concert as described in FIG. 2) may solve a central problem of internet radio service providers (e.g., Pandora) by retaining cultural significance related to a person's locations of association. For example, the radial distribution module 140 (e.g., that applies the radial algorithm 240 of FIG. 2 using a series of modules working in concert as described in FIG. 2) may be used to ‘create’ new radio stations, television stations, and/or mini alert broadcasts to a geospatially constrained area on one end, and provide a means for those ‘tuning in’ to consume information posted in a geospatial area that the listener cares about and/or associates themselves with. The information provided can be actionable in that the user 106 may be able to secure new opportunities through face to face human interaction and physical meeting not otherwise possible in internet radio scenarios.

The radial algorithm may be a set of instructions that may enable users (e.g., verified users, non-verified users) of the Nextdoor.com and Fatdoor.com websites and applications to broadcast their activities (e.g., garage sale, t-shirt sale, crime alert) to surrounding neighbors within a claimed neighborhood and to guests of a claimed neighborhood, according to one embodiment. The radial algorithm may be new because current technology does not allow for users of a network (e.g., Nextdoor.com, Fatdoor.com) to locally broadcast their activity to a locally defined geospatial area. With the radial algorithm, users of the network may communicate with one another in a locally defined manner, which may present more relevant information and activities, according to one embodiment. For example, if a verified user of the network broadcasts an item for sale, locally defined neighbors of the verified user may be much more interested in purchasing the product compared to if the item was for sale in a different town or city, according to one embodiment. The radial distribution module 140 may solve the problem of neighbors living in the locally defined geospatial area who don't typically interact, and allows them to connect within a virtual space that did not exist before, according to one embodiment. Prior to this invention of the radial algorithm 240 operating through the radial distribution module 140, community boards (e.g., job boards, for sale boards) were the only method of distributing content in a surrounding neighborhood effectively. However, there was no way to easily distribute content related to exigent circumstances and/or with urgency in a broadcast-like manner to those listening around a neighborhood through mobile devices until the various embodiments applying the radial distribution module 140 as described herein.

A radial algorithm 240 may be a method of calculating a sequence of operations, and in this case a sequence of radio operations, according to one embodiment. Starting from an initial state and initial input, the radial algorithm 240 describes a computation that, when executed, proceeds through a finite number of well-defined successive states, eventually producing radial patterned distribution (e.g., simulating a local radio station), according to one embodiment.

The work-opportunity listing server 100 may solve technical challenges through the radial distribution module 140 (e.g., that applies the radial algorithm 240 of FIG. 2 using a series of modules working in concert as described in FIG. 2) by implementing a vigorous screening process to screen out any lewd or vulgar content in one embodiment. For example, what may be considered lewd content sometimes could be subjective, and verified users could argue that we are restricting their constitutional right to freedom of speech through a crowd-moderation capability enabled by the radial distribution module 140 (e.g., that applies the radial algorithm 240 of FIG. 2 using a series of modules working in concert as described in FIG. 2), according to one embodiment. In one embodiment, verified users may sign an electronic agreement to screen their content and agree that the opportunity network 150 may delete any content that it deems inappropriate for broadcasting, through the radial distribution module 140 (e.g., that applies the radial algorithm 240 of FIG. 2 using a series of modules working in concert as described in FIG. 2) according to one embodiment.

The radial distribution module 140 (e.g., that applies the radial algorithm 240 of FIG. 2 using a series of modules working in concert as described in FIG. 2) may allow verified users to create and broadcast their own radio show, e.g., music, talk show, commercial, instructional contents, etc., and to choose their neighborhood(s) for broadcasting based on a claimed location, according to one embodiment. The radial distribution module 140 (e.g., that applies the radial algorithm 240 of FIG. 2 using a series of modules working in concert as described in FIG. 2) may allow users to choose the neighborhoods that they would want to receive the broadcasts, live and recorded broadcasts, and/or the types and topics of broadcasts that interest them.

The radial distribution module 140 (e.g., that applies the radial algorithm 240 of FIG. 2 using a series of modules working in concert as described in FIG. 2) based approach of the work-opportunity listing server 100 may be a completely different concept from the currently existing neighborhood (e.g. geospatial) social networking options. The radial distribution module 140 (e.g., that applies the radial algorithm 240 of FIG. 2 using a series of modules working in concert as described in FIG. 2) may also allow the user to create his/her own radio station, television station and/or other content such as the job broadcast data 102 and distribute this content around locations to users and preseeded profiles around them. The radial distribution module 140 (e.g., that applies the radial algorithm 240 of FIG. 2 using a series of modules working in concert as described in FIG. 2) can allow verified users to create their content and broadcast in the selected geospatial area. It also allows verified listeners to listen to only the relevant local broadcasts of their choice.

The radial distribution module 140 (e.g., that applies the radial algorithm 240 of FIG. 2 using a series of modules working in concert as described in FIG. 2) may be important because it may provide any verified user the opportunity to create his/her own radial broadcast message (e.g., can be audio, video, pictoral and/or textual content) and distribute this content to a broad group. Radial distribution module 140 (e.g., that applies the radial algorithm 240 of FIG. 2 using a series of modules working in concert as described in FIG. 2) may also allow verified listeners listen to any missed live broadcasts through the prerecorded features, according to one embodiment. Through this, the radial distribution module 140 (e.g., that applies the radial algorithm 240 of FIG. 2 using a series of modules working in concert as described in FIG. 2) changes the way social networks (e.g., Nextdoor, Fatdoor, Facebook, Path, etc.) operate by enabling location centric broadcasting to regions that a user cares about, according to one embodiment. Radial distribution module 140 (e.g., that applies the radial algorithm 240 of FIG. 2 using a series of modules working in concert as described in FIG. 2) may solve a technical challenge by defining ranges based on a type of job posting, a type of neighborhood, and/or boundary condition of a neighborhood by analyzing whether the job broadcast data 102 may be associated with a particular kind of job, a particular neighborhood, a temporal limitation, and/or through another criteria.

By using the radial distribution module 140 (e.g., that applies the radial algorithm 240 of FIG. 2 using a series of modules working in concert as described in FIG. 2) of the work-opportunity listing server 100 the verified user 16 may be able to filter irrelevant offers and information provided by broadcasts. In one embodiment, only the broadcasting user (e.g., the user 106) may be a verified user to create accountability for a particular broadcast and/or credibility of the broadcaster. In this embodiment, recipients 114 of the broadcast may not need to be verified users of the opportunity network. By directing traffic and organizing the onslaught of broadcasts, the radial distribution module 140 (e.g., that applies the radial algorithm 240 of FIG. 2 using a series of modules working in concert as described in FIG. 2) of the work-opportunity listing server 100 may able to identify the origins and nature of each group of incoming information and locate recipients 114 that are relevant/interested in the job broadcast data 102, maximizing the effective use of each broadcast.

The radial distribution module 140 (e.g., that applies the radial algorithm 240 of FIG. 2 using a series of modules working in concert as described in FIG. 2) of the work-opportunity listing server 100 may process the input data from the device 104 (e.g., a mobile device 504) in order to identify which notification(s) to broadcast to which individual(s). This may be separate from a traditional radio broadcast as it not only geographically constrains broadcasters and recipients 114 but also makes use of user preferences in order to allow broadcasters to target an optimal audience and allow recipients 114 to alter and customize what they consume. The user 106 may associate his/herself with a non-transitory address in order to remain constantly connected to their neighborhood and/or neighbors even when they themselves or their neighbors are away. The radial algorithm 240 may be also unique from a neighborhood social network (e.g., the geospatially constrained social network 142) as it permits users to broadcast offers, information, audio, video etc. to other users, allowing users to create their own stations.

In order to implement the radial distribution module 140 (e.g., that applies the radial algorithm 240 of FIG. 2 using a series of modules working in concert as described in FIG. 2), geospatial data may need to be collected and amassed in order to create a foundation on which users may sign up and verify themselves by claiming a specific address, associating themselves with that geospatial location. The radial distribution module 140 (e.g., that applies the radial algorithm 240 of FIG. 2 using a series of modules working in concert as described in FIG. 2) may then be able to utilize the geospatial database 122 to filter out surrounding noise and deliver only relevant data to recipients 114. In order to accomplish this, the radial distribution module 140 (e.g., that applies the radial algorithm 240 of FIG. 2 using a series of modules working in concert as described in FIG. 2) may be able to verify the reliability of geospatial coordinates, time stamps, and user information associated with the device 104 (e.g., a mobile device 504). In addition, threshold geospatial radii, private neighborhood boundaries, and personal preferences may be established in the work-opportunity listing server 100 and accommodated using the radial distribution module 140 (e.g., that applies the radial algorithm 240 of FIG. 2 using a series of modules working in concert as described in FIG. 2). The geospatial database 122 may work in concert with the radial distribution module 140 (e.g., that applies the radial algorithm 240 of FIG. 2 using a series of modules working in concert as described in FIG. 2) to store, organize, and manage broadcasts, pushpins, user profiles, preseeded user profiles, metadata, and epicenter 144 locations associated with the geospatially constrained social network 142 (e.g., a neighborhood social network such as Fatdoor.com, Nextdoor.com).

The radial algorithm 240 may be used to calculate relative distances between each one of millions of records as associated with each placed geo-spatial coordinate in the geospatially constrained social network 142 (e.g., a neighborhood social network such as Fatdoor.com, Nextdoor.com). Calculations of relative distance between each geospatial coordinate can be a large computational challenge because of the high number of reads, writes, modify, and creates associated with each geospatial coordinate added to the geospatially constrained social network 142 and subsequent recalculations of surrounding geospatial coordinates associated with other users and/or other profile pages based a relative distance away from a newly added set of geospatial coordinates (e.g., associated with the job broadcast data 102 and/or with other pushpin types). To overcome this computational challenge, the radial algorithm may leverage a massively parallel computing architecture 146 through which processing functions are distributed across a large set of processors accessed in a distributed computing system 148 through the network 101.

In order to achieve the utilization of the massively parallel computing architecture 146 in a context of a radial distribution function of a geospatially constrained social network 142, a number of technical challenges have been overcome in at least one embodiment. Particularly, the radial distribution module 140 constructs a series of tables based on an ordered geospatial ranking based on frequency of interaction through a set of ‘n’ number of users simultaneously interacting with the geospatially constrained social network 142, in one preferred embodiment. In this manner, sessions of access between the work-opportunity listing server 100 and users of the work-opportunity listing server 100 (e.g., the user 106) may be monitored based on geospatial claimed areas of the user (e.g., a claimed work and/or home location of the user), and/or a present geospatial location of the user. In this manner, tables associated with data related to claimed geospatial areas of the user and/or the present geospatial location of the user may be anticipatorially cached in the memory 124 to ensure that a response time of the geospatially constrained social network 142 may be not constrained by delays caused by extraction, retrieval, and transformation of tables that are not likely to be required for a current and/or anticipated set of sessions between users and the work-opportunity listing server 100.

In a preferred embodiment, an elastic computing environment may be used by the radial distribution module 140 to provide for increase/decreases of capacity within minutes of a database function requirement. In this manner, the radial distribution module 140 can adapt to workload changes based on number of requests of processing simultaneous and/or concurrent requests associated with job broadcast data 102 by provisioning and deprovisioning resources in an autonomic manner, such that at each point in time the available resources match the current demand as closely as possible.

The radial distribution module 140 (e.g., that applies the radial algorithm 240 of FIG. 2 using a series of modules working in concert as described in FIG. 2) may be a concept whereby a server communicating data to a dispersed group of recipients 114 over a network 101, which may be an internet protocol based wide area network (as opposed to a network communicating by radio frequency communications) communicates that data only to a geospatially-constrained group of recipients 114. The radial distribution module 140 (e.g., that applies the radial algorithm 240 of FIG. 2 using a series of modules working in concert as described in FIG. 2) may apply a geospatial constraint related to a radial distance away from an origin point, or a constraint related to regional, state, territory, county, municipal, neighborhood, building, community, district, locality, and/or other geospatial boundaries.

The radial distribution module 140 (e.g., that applies the radial algorithm 240 of FIG. 2 using a series of modules working in concert as described in FIG. 2) may be new as applied to data traveling over wide area networks using internet protocol topology in a geospatial social networking and commerce context, according to one embodiment. While radio broadcasts, by their nature, are transmitted in a radial pattern surrounding the origin point, there may be no known mechanism for restricting access to the data only to verified users of a service subscribing to the broadcast. As applied to wired computer networks, while techniques for applying geospatial constraints have been applied to search results, and to other limited uses, there has as yet been no application of geospatial constraint as applied to the various embodiments described herein using the radial distribution module 140 (e.g., that applies the radial algorithm 240 of FIG. 2 using a series of modules working in concert as described in FIG. 2).

The radial distribution module 140 (e.g., that applies the radial algorithm 240 of FIG. 2 using a series of modules working in concert as described in FIG. 2) may be roughly analogous to broadcast radio communications such as a) in broadcast radio, b) in wireless computer networking, and c) in mobile telephony. However, all of these systems broadcast their information promiscuously, making the data transmitted available to anyone within range of the transmitter who may be equipped with the appropriate receiving device. In contrast, the radial distribution module 140 (e.g., that applies the radial algorithm 240 of FIG. 2 using a series of modules working in concert as described in FIG. 2) herein describes a system in which networks are used to transmit data in a selective manner in that information may be distributed around a physical location of homes or businesses in areas of interest/relevancy.

The radial distribution module 140 (e.g., that applies the radial algorithm 240 of FIG. 2 using a series of modules working in concert as described in FIG. 2) may solve a problem of restricting data transmitted over networks to specific users who are within a specified distance from the individual who originates the data. In a broad sense, by enabling commerce and communications that are strictly limited within defined neighborhood boundaries, the radial distribution module 140 (e.g., that applies the radial algorithm 240 of FIG. 2 using a series of modules working in concert as described in FIG. 2) may enable the geospatially constrained social network 142 (e.g., a neighborhood social network such as Fatdoor.com, Nextdoor.com) communications, attacking the serious social conditions of anonymity and disengagement in community that afflict the nation and, increasingly, the world.

The radial distribution module 140 (e.g., that applies the radial algorithm 240 of FIG. 2 using a series of modules working in concert as described in FIG. 2) may comprise one or more modules that instruct the work-opportunity listing server 100 to restrict the broadcasting of the job broadcast data 102 to one or more parts of the geospatial area 117. For example, in the embodiment of FIG. 1, the radial distribution module 140 (e.g., that applies the radial algorithm 240 of FIG. 2 using a series of modules working in concert as described in FIG. 2) may instruct the work-opportunity listing server 100 to broadcast the job broadcast data 102 to the recipients 114 but not to the area outside the threshold radial distance 115.

In one or more embodiments, the radial distribution module 140 (e.g., that applies the radial algorithm 240 of FIG. 2 using a series of modules working in concert as described in FIG. 2) may allow the work-opportunity listing server 100 to function in manner that simulates a traditional radio broadcast (e.g., using a radio tower to transmit a radio frequency signal) in that both the work-opportunity listing server 100 and the radio broadcast are restricted in the geospatial scope of the broadcast transmission. In one or more embodiments, the radial distribution module 140 (e.g., that applies the radial algorithm 240 of FIG. 2 using a series of modules working in concert as described in FIG. 2) may prevent the broadcast of the job broadcast data 102 to any geospatial area to which the user 106 does not wish to transmit the job broadcast data 102, and/or to users that have either muted and/or selectively subscribed to a set of broadcast feeds.

The radial distribution module 140 (e.g., that applies the radial algorithm 240 of FIG. 2 using a series of modules working in concert as described in FIG. 2) may analyze the job broadcast data 102 to determine which recipients 114 may receive notification data 112 within a threshold radial distance 119 (e.g., set by the user 106 and/or auto calculated based on a type of job posting). The radial distribution module 140 (e.g., that applies the radial algorithm 240 of FIG. 2 using a series of modules working in concert as described in FIG. 2) may use a variety of parameters, including information associated with the job broadcast data (e.g. location of job, type of job, etc.) to determine the threshold radial distance 119.

The radial distribution module 140 (e.g., that applies the radial algorithm 240 of FIG. 2 using a series of modules working in concert as described in FIG. 2) may also determine which verified addresses associated with recipients 114 having verified user profiles are located within the threshold radial distance 119. The radial distribution module 140 (e.g., that applies the radial algorithm 240 of FIG. 2 using a series of modules working in concert as described in FIG. 2) may then broadcast the notification data 112 to the profiles and/or mobile devices of the verified users having verified addresses within the threshold radial distance 119.

The radial distribution module 140 (e.g., that applies the radial algorithm 240 of FIG. 2 using a series of modules working in concert as described in FIG. 2) may therefore simulate traditional radio broadcasting (e.g. from a radio station transmission tower) over the IP network. Thus, the radial distribution module 140 (e.g., that applies the radial algorithm 240 of FIG. 2 using a series of modules working in concert as described in FIG. 2) may allow the broadcast to include information and data that traditional radio broadcasts may not be able to convey, for example geospatial coordinates and/or real-time bi-directional communications. Additionally, the radial distribution module 140 (e.g., that applies the radial algorithm 240 of FIG. 2 using a series of modules working in concert as described in FIG. 2) may allow individual users low-entry broadcast capability without resort to expensive equipment and/or licensing by the Federal Communications Commission (FCC).

Another advantage of this broadcast via the radial distribution module 140 (e.g., that applies the radial algorithm 240 of FIG. 2 using a series of modules working in concert as described in FIG. 2) may be that it may bypass obstructions that traditionally disrupt radio waves such as mountains and/or atmospheric disturbances. Yet another advantage of the radial distribution module 140 (e.g., that applies the radial algorithm 240 of FIG. 2 using a series of modules working in concert as described in FIG. 2) may be that it may expand the physical distance of broadcast capability without resort to the expense ordinarily associated with generating powerful carrier signals. In yet another advantage, the radial distribution module 140 (e.g., that applies the radial algorithm 240 of FIG. 2 using a series of modules working in concert as described in FIG. 2) may allow for almost unlimited channels and/or stations as compared to traditional radio where only a narrow band of electromagnetic radiation has been appropriated for use among a small number of entities by government regulators (e.g. the FCC).

The user 106 may be an individual who operates the device 104 (e.g., a mobile device 504) to generate the job broadcast data 102. It will be understood by those skilled in the art that the verified nature of the user may be an optional characteristic in an alternate embodiment. This means that in an alternate embodiment, any user (whether verified or not) may generate the job broadcast data 102 through the device 104 (e.g., a mobile device 504). In another alternative embodiment, the user 106 may be an electronic sensor, such as a detection sensor device (e.g., a sensory detection sensor device such as a motion detector, a chemical detection device, etc.), and/or an appliance (e.g., such as a refrigerator, a home security network, and/or a motion detector). It should also be noted that the ‘mobile’ nature of the device 104 may be optional in yet another alternative embodiment. In such an alternate embodiment, any computing device, whether mobile/portable or fixed in location may generate the job broadcast data 102.

The cellular network 108 may be associated with a telephone carrier (e.g., such as AT&T, Sprint, etc.) that provides an infrastructure through which communications are generated between the work-opportunity listing server 100 and the service providers 109 using the radial algorithm 240. For example, the cellular network 108 may provide a communication infrastructure through which the job broadcast data 102 may be communicated as voice and/or text messages through telephones (e.g., standard telephones and/or smart phones) operated by at least some of the service providers 109 of FIG. 1. It should be understood that in one embodiment, the service providers 109 are paid subscribers/customers of the geospatially constrained social network 142 in a manner such that each of the service providers 109 may pay a fee per received job broadcast data 102, and/or each hired engagement to the geospatially constrained social network 142. The service providers 109 may pay extra to be permitted access to receive the job broadcast data 102 even when they do not have a transitory and/or non-transitory connection to a neighborhood if they service that neighborhood area though operating their business outside of it. For this reason, FIG. 1 visually illustrates that the service providers 109 may be located (e.g., principal business address) outside the threshold radial distance 119.

The cellular network 108 (e.g., a mobile network) may be a wireless network distributed over land areas called cells, each served by at least one fixed-location transceiver, known as a cell site or base station through which the job broadcast data 102 is distributed from the work-opportunity listing server 100 to telephones of the service providers 109 using the radial distribution module 140 (e.g., that applies the radial algorithm 240 of FIG. 2 using a series of modules working in concert as described in FIG. 2), according to one embodiment. The cellular network 108 may use a set of frequencies from neighboring cells, to avoid interference and provide guaranteed bandwidth within each cell, in one embodiment.

When joined together these cells of the cellular network 108 may provide radio coverage over a wide geographic area through the cellular network 108 in a manner that ensures that the job broadcast data 102 may be simultaneously communicated via both IP networks (e.g., to the recipients 114) and/or to the service providers 109 through the cellular network 108. It will be appreciated that the radial distribution module 140 (e.g., that applies the radial algorithm 240 of FIG. 2 using a series of modules working in concert as described in FIG. 2) in effect permits simultaneous updates to claimed user pages, unclaimed (preseeded) user pages in a geospatially constrained social network 142 (e.g., neighborhood social network) based on a geospatial location of the device 104 (e.g., a mobile device 504) in a manner that simulates a radio (RF) based network separately from the concepts described in conjunction with the cellular network 108. However, it will be understood that the radial distribution module 140 (e.g., that applies the radial algorithm 240 of FIG. 2 using a series of modules working in concert as described in FIG. 2) may be not restricted to such topology and can multimodally communicate through different networks, such as through the cellular network 108 described in FIG. 1.

The service providers 109 may be locations, devices, and/or mobile phones associated with individuals and/or agencies for hire. The service providers 109 may be notified when a work opportunity in an area that they care about including a non-transitory location (e.g., around where they live and/or work, regardless of where they currently are) and a transitory location (e.g., where they currently are) is posted using the device 104 (e.g., a mobile device 504) as the job broadcast data 102.

The service providers 109 are illustrated in FIG. 1 as including a hardware store 110A, a homeless shelter 110B, a career center 110C, and a set of professional(s) 110. In this manner, mobile devices and/or desktop computers operated by the service providers 109 may be alerted whenever the job broadcast data 102 is posted in and/or around their neighborhood through a push notification (e.g., an alert popping up on their phone), through an email, a telephone call, and/or a voice message delivered to the particular mobile device operated by each of the service providers 109 using the radial distribution module 140 (e.g., that applies the radial algorithm 240 of FIG. 2 using a series of modules working in concert as described in FIG. 2).

The job broadcast data 102 may be delivered as notification data 112 (which may include a number of attributes as later will be described with reference to FIG. 2) from the work-opportunity listing server 100 to the recipients 114 and/or to the service providers 109 using the radial distribution module 140 (e.g., that applies the radial algorithm 240 of FIG. 2 using a series of modules working in concert as described in FIG. 2) of the work-opportunity listing server 100.

The recipients 114 may be individuals that have claimed a profile (e.g., verified their profile through a postcard, a telephone lookup, a utility bill) associated with a particular non-transitory address (e.g., a home address, a work address) through a geospatial social network (e.g., a geospatially constrained social network 142 (e.g., a neighborhood social network such as Fatdoor.com, Nextdoor.com)) through which the work-opportunity listing server 100 operates. The recipients 114 may be in a geo-fenced area, in that an epicenter 144 of a broadcast message from the device 104 (e.g., a mobile device 504) may be a center through which a radial distance is calculated based on a characteristic of the job broadcast data 102. For example, a short term job (e.g., moving furniture) may be delivered only to an immediate 0.1 mile radius, and a permanent job opening may be automatically delivered to a broader 0.6 mile radius either automatically and/or through a user defined preference (e.g., set by the user 106).

It should be appreciated that individuals in an area outside the threshold radial distance 115 may not receive the job broadcast data 102 because their geospatial address may be outside a radial boundary surrounding an epicenter 144 in which the job broadcast data 102 originates. Additionally, the threshold radial distance 119 may be confined on its edges by a geospatial polygon at a juncture between area defined by recipients 114 and the area outside the threshold radial distance 115, according to one embodiment.

FIG. 2 is an exploded view of the radial distribution module 140 of FIG. 1 that applies the radial algorithm 240, according to one embodiment.

Particularly, FIG. 2 illustrates an exploded view of the radial distribution module 140, according to one embodiment. A variety of software instruction sets and/or hardware components form the radial distribution module 140, according to one embodiment. Select ones of these software instruction sets and/or hardware components utilize the radial algorithm 240 to perform functions related to radially distributing information to pre-seeded user profiles, user profiles, and telephone devices (e.g., land based phones, circuit switched phones).

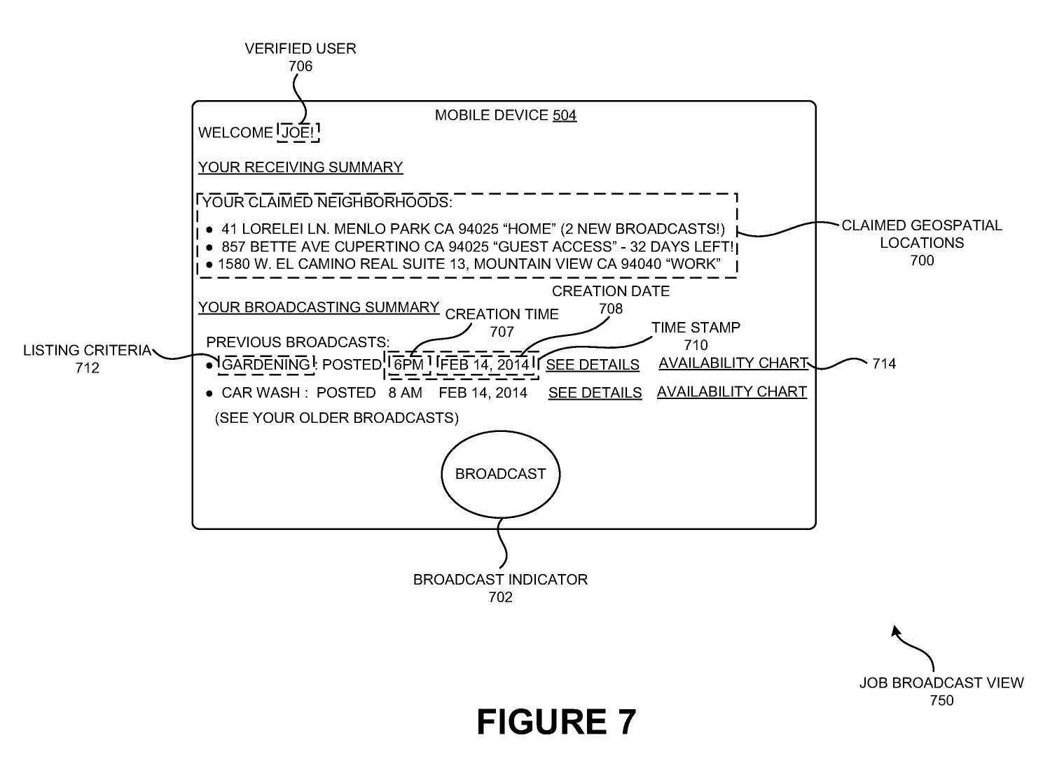

A validation module 200 may determine that a job broadcast data 102 generated through a mobile device 504 may be associated with a verified user (e.g., the user 106 of FIG. 1 as described as the verified user 706 in FIG. 7) of the work-opportunity listing server 100) using a processor 120 and/or a memory 124. In addition, the validation module 200 may determine that the broadcast data (e.g., the job broadcast data 102) is generated by the validated user (e.g., the user 106 of FIG. 1 as described as the verified user 706 in FIG. 7) of the neighborhood broadcast system (e.g., of the geospatially constrained social network 142) when analyzing that the broadcast data (e.g., the job broadcast data 102) is associated with the mobile device 504. The validation module 200 may apply the radial algorithm 240 to determine if the verified user 706 may be in a validated geospatial location based on previous history of the verified user 706, according to one embodiment.

In addition, the validation module 200 may ensure that a set of geospatial coordinates 103 associated with the job broadcast data 102 generated through the mobile device 504 are trusted based on a claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100).

A time stamp module 202 may determine that a time stamp 710 associated with a creation date 708 and/or a creation time 707 of the job broadcast data 102 generated through the mobile device 504 may be trusted based on the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100). A listing module 272 may determine a listing criteria 712 associated with the job broadcast data 102 including a description, a photograph, a video, a salary, a fixed fee amount, a category, a functional status of a job offered through the job broadcast data 102, wherein the job may be a household job, a repair job, a maintenance job, a professional job and/or a career opportunity.

A charting module 204 may populate an availability chart 714 when the job associated with the listing criteria 712 may be posted, wherein the availability chart 714 includes a target candidate living area radius, a start timing, an hours per day, an hours per month, a professional qualification criteria and/or a timing criteria. An application module 274 may communicate the broadcast data (e.g., the job broadcast data 102) to the neighborhood broadcasting system when the broadcast data (e.g., the job broadcast data 102) may be processed, and/or to associate the verified user (e.g., the user 106 of FIG. 1 as described as the verified user 706 in FIG. 7) with a verified user (e.g., the user 106 of FIG. 1 as described as the verified user 706 in FIG. 7) profile in the neighborhood broadcasting system through the application on the mobile device 504.

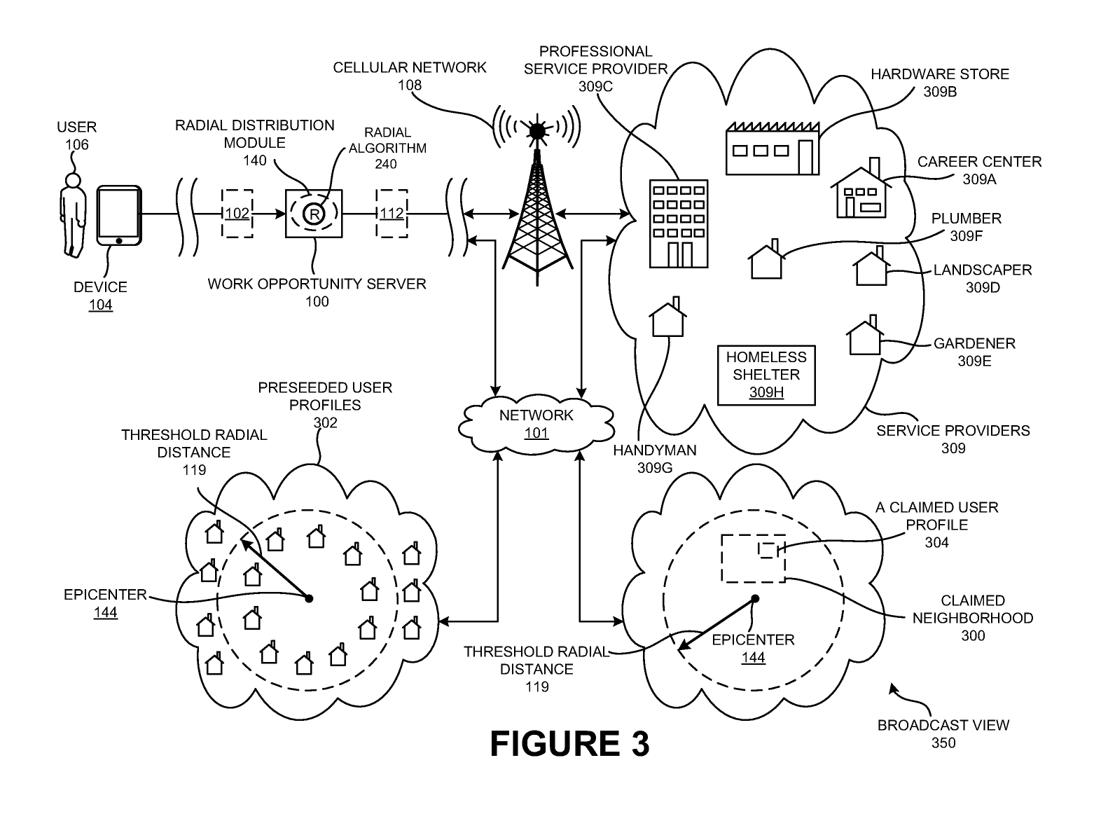

A pushpin module 206 may present the job broadcast data 102 generated through the mobile device 504 as a job alert pushpin of the job broadcast in a geospatial map surrounding pre-populated residential and/or business listings in a surrounding vicinity, such that the job alert pushpin of the job broadcast may be automatically presented on the geospatial map in addition to being presented on the set of user profiles (e.g., preseeded user profiles 302 and/or claimed user profiles 304 as described in FIG. 3 having associated verified addresses in the threshold radial distance 119 from the set of geospatial coordinates 103 associated with the job broadcast data 102 generated through the mobile device 504 of the verified user (e.g., the user 106 of FIG. 1 as described as the verified user 706 in FIG. 7) of the work-opportunity listing server 100).

A radial distribution module 140 may radially distribute the job broadcast data 102 generated through the mobile device 504 through an on-page posting, an electronic communication, and/or a push notification delivered to desktop and/or mobile device 504s associated with users and/or their user profiles (e.g., preseeded user profiles 302 and/or claimed user profiles 304 as described in FIG. 3) around an epicenter defined at the set of geospatial coordinates 103 associated with the job broadcast data 102 generated through the mobile device 504 to all subscribed user profiles (e.g., preseeded user profiles 302 and/or claimed user profiles 304 as described in FIG. 3) in a circular geo-fenced area defined by the threshold distance from the set of geospatial coordinates 103 associated with the job broadcast data 102 generated through the mobile device 504 through the radial algorithm 240 of a neighborhood broadcasting system that measures a distance away of each address associated with each user profile from the current geospatial location at the epicenter. A placement module 232 may enable the verified user (e.g., the user 106 of FIG. 1 as described as the verified user 706 in FIG. 7) to drag and/or drop the job alert pushpin on any location on the geospatial map, and/or automatically determining a latitude and/or a longitude associated a placed location.

A notification module 208 may automatically notify a career center 309A, a hardware store 309B, a professional service provider 309C, a landscaper 309D, a gardener 309E, a plumber 309F, a handyman 309G, and/or a homeless shelter 309H in a surrounding geospatial area to the set of geospatial coordinates 103 associated with the job broadcast data 102 generated through the mobile device 504. An extraction module 234 may separate the geospatial coordinates 103 from a metadata associated with the job broadcast data 102 generated through the mobile device 504 when verifying that the set of geospatial coordinates 103 associated with the job broadcast data 102 generated through the mobile device 504 are trusted based on the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100).

A matching module 210 may determine a relative match between a persistent clock associated with the work-opportunity listing server 100 and/or a digital clock of the mobile device 504 to determine that the time stamp 710 associated with the creation date 708 and/or time of the job broadcast data 102 generated through the mobile device 504 may be accurate and/or therefore trusted. A deletion module 236 may automatically remove a publishing of the job broadcast data 102 generated through the mobile device 504 on a set of user profiles (e.g., preseeded user profiles 302 and/or claimed user profiles 304 as described in FIG. 3 having associated verified addresses in the threshold radial distance 119 from the set of geospatial coordinates 103 associated with the job broadcast data 102 generated through the mobile device 504 of the verified user (e.g., the user 106 of FIG. 1 as described as the verified user 706 in FIG. 7) of the work-opportunity listing server 100) based on a job alert expiration time. A plotting module 238 may geocode a set of residential addresses each associated with a resident name in a neighborhood surrounding the mobile device 504.

A data-seeding module 241 may prepopulate the set of residential addresses each associated with the resident name as the set of user profiles (e.g., preseeded user profiles 302 and/or claimed user profiles 304 as described in FIG. 3 in the threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100) in a neighborhood curation system (e.g., part of the geospatially constrained social network 142) communicatively coupled with the work-opportunity listing server 100. A modification module 242 may alter content in each of the set of user profiles (e.g., preseeded user profiles 302 and/or claimed user profiles 304 as described in FIG. 3). A discovery module 244 may track the modified content through the neighborhood curation system (e.g., part of the geo spatially constrained social network 142). An undo module 246 may generate a reversible history journal associated with each of the set of user profiles (e.g., preseeded user profiles 302 and/or claimed user profiles 304 as described in FIG. 3 such that a modification of the verified user (e.g., the user 106 of FIG. 1 as described as the verified user 706 in FIG. 7) can be undone on a modified user profile page. A reputation module 248 may determine an editing credibility of the verified user (e.g., the user 106 of FIG. 1 as described as the verified user 706 in FIG. 7) based on an edit history of the verified user (e.g., the user 106 of FIG. 1 as described as the verified user 706 in FIG. 7) and/or a community contribution validation of the verified user (e.g., the user 106 of FIG. 1 as described as the verified user 706 in FIG. 7) by other users of the neighborhood curation system (e.g., part of the geospatially constrained social network 142).

A publishing module 214 may automatically communicate the job broadcast data 102 generated through the mobile device 504 to a set of user profiles (e.g., preseeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100) using the radial algorithm 240. A claiming module 250 may process a claim request of the verified user (e.g., the user 106 of FIG. 1 as described as the verified user 706 in FIG. 7) generating the job broadcast data 102 generated through the mobile device 504 to be associated with an address of the neighborhood curation system (e.g., part of the geospatially constrained social network 142). A private-neighborhood module 252 may determine if the claimable neighborhood in the neighborhood curation system (e.g., part of the geospatially constrained social network 142) may be associated with a private neighborhood community in the claimable neighborhood of the neighborhood curation system (e.g., part of the geospatially constrained social network 142).

An association module 216 may associate the verified user (e.g., the user 106 of FIG. 1 as described as the verified user 706 in FIG. 7) with the private neighborhood community in the claimable neighborhood of the neighborhood curation system (e.g., part of the geospatially constrained social network 142) if the private neighborhood community has been activated by the verified user (e.g., the user 106 of FIG. 1 as described as the verified user 706 in FIG. 7) and/or a different verified user (e.g., the user 106 of FIG. 1 as described as the verified user 706 in FIG. 7). A boundary module 254 may permit the verified user (e.g., the user 106 of FIG. 1 as described as the verified user 706 in FIG. 7) to draw a set of boundary lines in a form of a geospatial polygon such that the claimable neighborhood in a geospatial region surrounding the claim request creates the private neighborhood community in the neighborhood curation system (e.g., part of the geo spatially constrained social network 142) if the private neighborhood community may be inactive. An address type module 256 may verify the claim request of the verified user (e.g., the user 106 of FIG. 1 as described as the verified user 706 in FIG. 7) generating the job broadcast data 102 generated through the mobile device 504 to be associated with a neighborhood address of the neighborhood curation system (e.g., part of the geospatially constrained social network 142) when the address may be determined to be associated with a work address and/or a residential address of the verified user (e.g., the user 106 of FIG. 1 as described as the verified user 706 in FIG. 7).

A concurrency module 258 may simultaneously publish the job broadcast data 102 generated through the mobile device 504 on the private neighborhood community associated with the verified user (e.g., the user 106 of FIG. 1 as described as the verified user 706 in FIG. 7) generating the job broadcast data 102 generated through the mobile device 504 in the threshold radial distance 119 from the address associated with the claim request of the verified user (e.g., the user 106 of FIG. 1 as described as the verified user 706 in FIG. 7) of the neighborhood curation system (e.g., part of the geospatially constrained social network 142) when automatically publishing the job broadcast data 102 generated through the mobile device 504 on a set of user profiles (e.g., preseeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100) based on a set of preferences of the verified user (e.g., the user 106 of FIG. 1 as described as the verified user 706 in FIG. 7) using the radial algorithm 240.

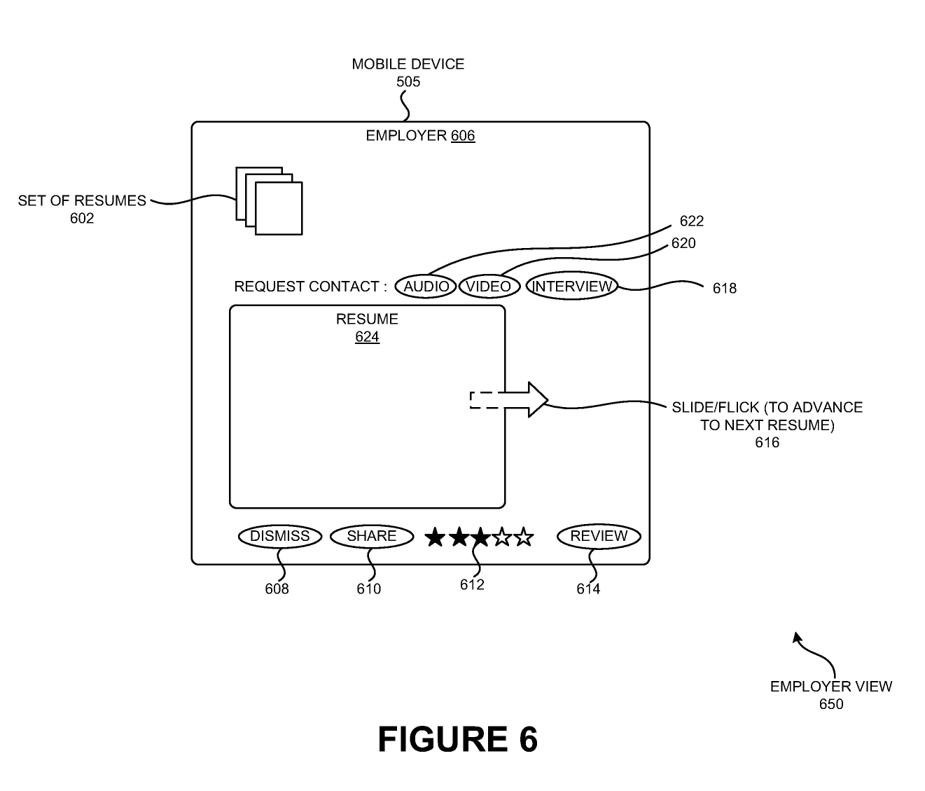

A download module 260 may automatically download a set of resumes to the employer device 505 of FIG. 6, wherein an employer 606 may be the verified user (e.g., the user 106 of FIG. 1 as described as the employer 606 in FIG. 6), and/or to provide an interface to the employer 606 such that the employer 606 can use a haptic ‘slide/flick’ gesture 616 in a horizontal and/or a vertical fashion to switch a viewing pane associated with a resume. An employer module 222 may analyze a response of the employer 606 being at least one of a dismiss function 608, a share function 610, a rating 612 function, a review function 614 and/or an interview function 618 of an applicant for the job associated with the job broadcast data 102 through the work-opportunity listing server 100. The employer module 222 may automatically initiate a video communication 620 and/or an audio communication 622 between the employer device 505 of the employer 606 and/or another mobile device 504 of the potential job applicant through the work-opportunity listing server 100 based on the interview function 618 of the applicant for the job associated with the job broadcast data 102 through the work-opportunity listing server 100.

An applicant module 224 may permit the job applicant and/or other job applicants to view the rating 612 and/or the review function 614 provided by the employer 606 for each of the potential job applicants based on a participation criteria set by the employer 606 and/or the job applicant, such that each job applicant may be able to view rating 612s and/or review 614s of each participating candidate for the job associated with the job broadcast data 102, and/or to permit each job applicant for the job associated with the job broadcast data 102 to communicate with each other and/or form social connections with each other based on the participation criteria set by the employer 606 and/or the job applicant, such that each job applicant may be able to form social connections with each participating candidate for the job associated with the job broadcast data 102.

A historical applicant module 226 may permit participating employers in the work-opportunity listing server 100 to see previous rating 612s, interview function 618 comments, review 614s, prescreen questions, and/or background checks of across a plurality of applicants applying for a plurality jobs through the work-opportunity listing server 100 such that different employers benefit from previous diligence of at one of previous rating 612s, interview function 618 comments, review 614s, prescreen questions, and/or background checks by participating employers with each applicant to the job that has previously applied for different jobs through the work-opportunity listing server 100. A summary module 262 may generate a summary data to the employer 606 generating the job broadcast data 102 generated through the mobile device 504 of how many user profile pages were updated with an alert of the job broadcast data 102 generated through the mobile device 504 when publishing the job broadcast data 102 generated through the mobile device 504 in the private neighborhood community and/or the set of user profiles (e.g., preseeded user profiles 302 and/or claimed user profiles 304 as described in FIG. 3 having associated verified addresses in the threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100) based on the set of preferences of the verified user (e.g., the user 106 of FIG. 1 as described as the verified user 706 in FIG. 7).

A live broadcast module 228 may live broadcast the job broadcast data 102 generated through the mobile device 504 to the different verified user (e.g., the user 106 of FIG. 1 as described as the verified user 706 in FIG. 7) and/or other verified user (e.g., the user 106 of FIG. 1 as described as the verified user 706 in FIG. 7) in the private neighborhood community and/or currently within the threshold radial distance 119 from the current geo spatial location through the work-opportunity listing server 100 through a multicast algorithm such that a live broadcast multicasts to a plurality of data processing systems associated with each of the different user and/or the other verified user (e.g., the user 106 of FIG. 1 as described as the verified user 706 in FIG. 7) simultaneously when the mobile device 504 of the verified user (e.g., the user 106 of FIG. 1 as described as the verified user 706 in FIG. 7) generating the live-broadcast enables broadcasting of the job broadcast data 102 generated through the mobile device 504 to any one of a geospatial vicinity around the mobile device 504 of the verified user (e.g., the user 106 of FIG. 1 as described as the verified user 706 in FIG. 7) generating the broadcast and/or in any private neighborhood community in which the verified user (e.g., the user 106 of FIG. 1 as described as the verified user 706 in FIG. 7) has a non-transitory connection.

A bi-directional communication module 230 may permit the different verified user (e.g., the user 106 of FIG. 1 as described as the verified user 706 in FIG. 7) and/or other verified user (e.g., the user 106 of FIG. 1 as described as the verified user 706 in FIG. 7) in the private neighborhood community to bi-directionally communicate with the verified user (e.g., the user 106 of FIG. 1 as described as the verified user 706 in FIG. 7) generating the broadcast through the work-opportunity listing server 100. A moderation module 264 may apply a crowdsourced moderation algorithm in which multiple neighbors to a geospatial area determine what content contributed to the work-opportunity listing server 100 persists and/or which may be deleted. A muting module 266 may permit users to mute messages of specific verified user (e.g., the user 106 of FIG. 1 as described as the verified user 706 in FIG. 7) to prevent misuse of the work-opportunity listing server 100.

A threshold module 268 may automatically set the threshold distance between 0.2 and/or 0.4 miles from the set of geospatial coordinates 103 associated with the job broadcast data 102 generated through the mobile device 504 to optimize a relevancy of the live-broadcast. A non-transitory module 270 may determine any private neighborhood community in which the verified user (e.g., the user 106 of FIG. 1 as described as the verified user 706 in FIG. 7) has a non-transitory connection may be a residential address of the verified user (e.g., the user 106 of FIG. 1 as described as the verified user 706 in FIG. 7) and/or a work address of the verified user (e.g., the user 106 of FIG. 1 as described as the verified user 706 in FIG. 7) that has been confirmed by the work-opportunity listing server 100 as being associated with the verified user (e.g., the user 106 of FIG. 1 as described as the verified user 706 in FIG. 7).

FIG. 3 is a broadcast view that demonstrates how the radial distribution module of FIG. 1 is used to communicate a job opportunity broadcast data to claimed user profiles, pre-seeded user profiles, and to telephone devices through a heterogeneous network formed through the internet protocol network of FIG. 1 and through a cellular network, according to one embodiment.

Particularly, FIG. 3 illustrates a broadcast view 350, according to one embodiment. FIG. 3 introduces a claimed neighborhood 300, a set of preseeded user profiles 302, and a claimed user profile 304, and their relationships with elements previously described in FIG. 1. In addition, FIG. 3 explains the set of service providers 109 of FIG. 1 to include a career center 309A, a hardware store 309B, a professional service provider 309C, a landscaper 309D, a gardener 309E, a plumber 309F, a handyman 309G, and a homeless shelter 309H.

In FIG. 3, the claimed neighborhood 300 may refer to a region that may be claimed by the user 106 as being associated with a non-transitory location (e.g., a work address, a home address) of the user 106. The preseeded user profiles 302 may refer to address information from people and/or business directories that has been prepopulated in the geospatial social map and/or may be associated with manually placed pushpins on the geospatial map in the geospatially constrained social network 142 of FIG. 1. The claimed user profile 304 may refer to the verified user 706 associated with a verified address in the geospatial social map and/or may be associated with claimed pushpin (e.g., a previously preseeded residential and/or business profile) on the geospatial map in the geospatially constrained social network 142 of FIG. 1.

The career center 309A, the hardware store 309B, the professional service provider 309C, the landscaper 309D, the gardener 309E, the plumber 309F, the handyman 309G, and the homeless shelter 309H may receive the job broadcast data 102 through their mobile devices, desktop devices, and/or through their cellular telephones. The career center 309A, the hardware store 309B, the professional service provider 309C, the landscaper 309D, the gardener 309E, the plumber 309F, the handyman 309G, and the homeless shelter 309H may receive the job broadcast data 102 and may bi-directionally interact with the service providers 109 through either cellular and/or through the network 101 (e.g., an internet protocol network). When a job opportunity is filled by the user 106 interacting with any one of the recipients based on the bi-directional communication, the user 106 may be able to hire, manage, and pay any one or more of the career center 309A, the hardware store 309B, the professional service provider 309C, the landscaper 309D, the gardener 309E, the plumber 309F, the handyman 309G, and the homeless shelter 309H, that may receive the job broadcast data 102 through the work-opportunity listing server 100.

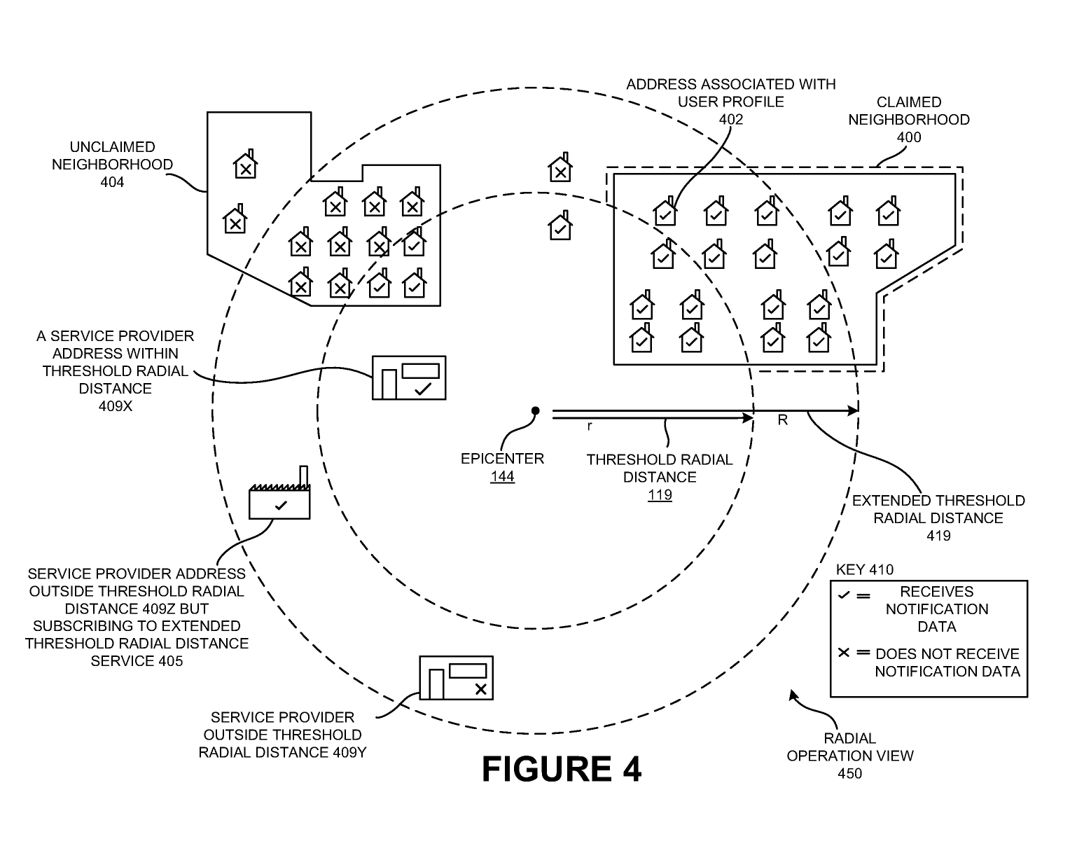

The notification data 112 may be communicated through the network 101 to the preseeded user profiles 302 within a threshold radial distance 119 of the epicenter 144. Alternately, the notification data 112 may be communicated through the network 101 to different ones of the claimed user profile 304 within the claimed neighborhood 300 that are located within the threshold radial distance 119 from the epicenter 144. Additionally, as described in FIG. 4, it will be understood that the claimed neighborhood 300 may be situated partially within the threshold radial distance 119 and partially outside the threshold radial distance 119, yet the notification data 112 received by of the recipients 114 (e.g., having a claimed user profile) may be propagated to other claimed user profiles within the claimed neighborhood 300 even though they are outside the threshold radial distance 119.

The notification data 112 may also be communicated through the cellular network 108 or through the network 101 to the set of service providers 309. For example, the career center 309A may use the opportunity network 150 to monitor jobs in a neighborhood and publish these jobs to residents around a geospatial area of the neighborhood. In addition, the hardware store 309B may attract day laborers from different parts of a city who desire work in a region around the hardware store. The professional service provider 309C, the landscaper 309D, the gardener 309E, and the handyman 309G may service a particular neighborhood and may be alerted of a new opportunity based on a subscription they pay to access broadcasts from areas that they service. Additionally, it should be understood that other types of businesses may receive the notification data 112. For example, additional service providers such as retail shops, wholesale stores, construction jobsites, and other parties or entities that require new employees, independent contractors, temporary workers or day labor may receive the notification data 112. Service providers may also be individual users who are in need of work around their home or office.

FIG. 4 is a radial operation view 450 that illustrates an expansion of a threshold radial distance based on a claimed neighborhood 400 at a radial boundary surrounding the epicenter 144 formed by geospatial coordinates of the device of FIG. 1, according to one embodiment. FIG. 4 illustrates a claimed neighborhood 400, an address associated with a user profile 402, an unclaimed neighborhood 404, a service provider address outside the threshold radial distance as described in operation 409Z but subscribing to extend the threshold radial distance as described in operation 405, a service provider address within the threshold radial distance as described in operation 409X, a service provider within the threshold radial distance as described in operation 409X, a service provider outside the threshold radial distance in operation 409Y, and a key 410. The key 410 describes that a ‘checkmark’ inside a home in either the claimed neighborhood 400 and/or the unclaimed neighborhood 404 indicates that the job broadcast data 102 reaches a user associated with that address at a radial geospatial distance away. In contrast, the key 410 describes that an ‘X mark’ inside a home in either the claimed neighborhood 400 and/or the unclaimed neighborhood 404 indicates that the job broadcast data 102 does not reach a user associated with that address at a radial geospatial distance away.

Particularly, in FIG. 4, an address associated with each user profile 402 is illustrated, according to one embodiment. In FIG. 4, because the claimed neighborhood 400 is partially within the threshold radial distance ‘r’, every verified user in the claimed neighborhood 400 receives the job broadcast data 102, according to one embodiment. Thereby, the radial broadcast distance ‘r’ is extended to a′ as illustrated in FIG. 4 (e.g., the extended threshold radial distance 419 of FIG. 4). It should be understood that in an alternate embodiment, the radial broadcast of the job broadcast data 102 may not extend to the entire group of users of the claimed neighborhood 400. However, to promote neighborhood communication and cooperation, the job broadcast data 102 is illustrated as being extended to the claimed neighborhood 400 in the embodiment of FIG. 4.

It should be also noted that in some embodiments, the “preseeded user profiles” may be users that have previously signed up for the geospatially constrained social network 142, as opposed to users that have been preseeded there in a social network. For example, in one alternate embodiment, each of the claimed neighborhood 400 may serve as an approximate to actual radial distribution, in that broadcast messages are solely sent to claimed neighborhoods (e.g., private claimed neighborhoods) of actual users in a vicinity of a broadcast (rather than to public profiles).

FIG. 4 also illustrates an unclaimed neighborhood 404. The unclaimed neighborhood 404 may be preseeded based on public data, according to one embodiment. The unclaimed neighborhood has within it a series of addresses (e.g., associated with non-transitory homes and/or business locations), according to one embodiment as illustrated in FIG. 4. Those addresses in the unclaimed neighborhood 404 to whom the job broadcast data 102 is delivered have a ‘checkmark’, according to one embodiment. In contrast, those addresses in the unclaimed neighborhood 404 to whom the job broadcast data 102 is not delivered have an ‘X mark’, as illustrated in FIG. 4. Particularly, addresses in the radial boundary ‘r’ have a check mark, whereas addresses that extend from the radial boundary ‘r’ (e.g., and therefore outside the threshold radial distance 119) are marked with the ‘X mark’. In this example embodiment of FIG. 4 showing the unclaimed neighborhood 404, the addresses within the threshold radial distance 119 are the addresses that receive the job broadcast data 102.

Also illustrated in FIG. 4 is the concept of the service provider address within the threshold radial distance as shown in operation 409X, the service provider address outside the threshold radial distance but subscribing to extend threshold radial distance service as shown in operation 405, and the service provider outside the threshold radial distance as illustrated in operation 409Y. Each of these different operations will be compared and contrasted. The service provider address in operation 409X may receive the job broadcast data 102 because the service provider in this example embodiment of FIG. 4 is within the threshold radial distance 119, according to one embodiment. The service provider address in operation 405 may receive the job broadcast data 102 because they provide a consideration (e.g., pay a monthly subscription, annual fee, and/or pay per access/use fee) to the geospatially constrained social network 142, even though the service provider in operation 405 does not have a physical address within the threshold radial distance 119. The geospatially constrained social network 142 (e.g., or work-opportunity listing server 100) may verify, confirm, and/or ask for an assurance that the service provider actually provides services to homes/businesses in the threshold radial distance 119. The geospatially constrained social network 142 (and other the work-opportunity listing server 100) may request feedback, reviews, and comments from homes/businesses in the geospatially constrained social network 142 for the service providers in operation 405 and operation 409X to ensure that they continue to be recommended and/or are permitted to participate in the threshold radial distance 119 around the epicenter 144 (e.g., where the broadcast originates) in the geospatially constrained social network 142. Operation 409Y indicates that a service provider outside the threshold radial distance 119 does not receive the job broadcast data 102, and therefore cannot participate bi-directionally in the geospatially constrained social network 142.

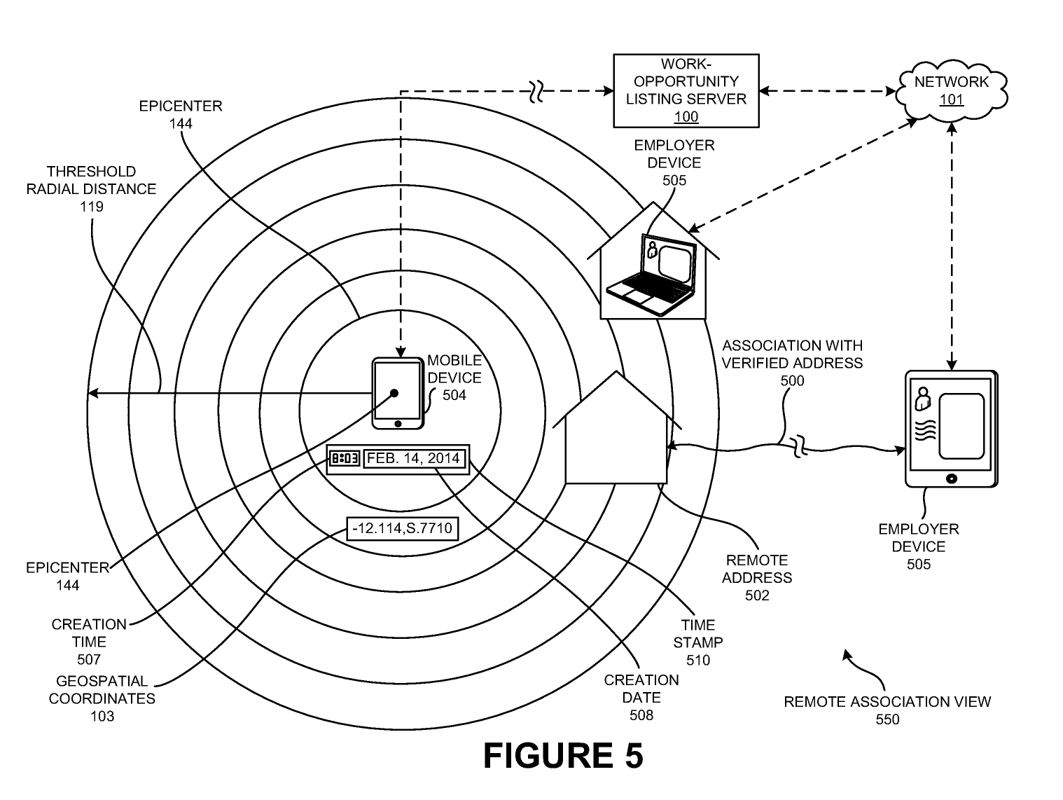

FIG. 5 illustrates a remote association view 550 in which a employer device 505 (e.g., the employer device) of an employer receives the job broadcast data of FIG. 3 based on a non-transitory claimed address associated with a profile of the employer even when the employer's mobile device is outside a threshold radial distance of a broadcast, according to one embodiment.

Particularly, FIG. 5 illustrates an operation 500 which illustrates the employer device can be associated to a remote address 502, and a time stamp 510 associated with a creation time 507, a creation date 508, and a set of geospatial coordinates 103. The remote address 502 may be a non-transitory location such as a home and/or a work address of the employer (e.g., the user 106 generating the job broadcast data 102), according to one embodiment. The non-transitory location may be a place of domicile (e.g., a home) and/or a place of situs (e.g., a physical location and/or a principle place of business) of a property (e.g., a work address) and/or business associated with the user 106), according to one embodiment. The concept illustrates that the employer device may be located at a physical location outside the threshold radial distance 119 and still get the job broadcast data 102 if the employer device (e.g., the employer device 505) has verified an address at a location that they care about and/or are associated with (e.g., a location in which they live, work, and/or have guest access) that is within the threshold radial distance 119. In other words, the user 106 may receive broadcast (e.g., the job broadcast data 102 which may be live streamed and/or through after the event notifications) related to a radial distance from their home and/or work even when physically at a location outside their claimed non-transitory location.

FIG. 6 is an employer view 650 that explains how the employer of FIG. 5 manages and communicates with a set of applicants based on the job broadcast data 102, according to one embodiment. Particularly, FIG. 6 illustrates a set of resumes 602, an employer 606, a dismiss function 608, a share function 610, a rating 612 function, a review function 614, a haptic ‘slide/flick’ gesture 616, an interview function 618, a video communication 620, an audio communication 622, and a resume 624, according to one embodiment.

In FIG. 6, the set of resumes may be automatically downloaded to the employer device 505 (the employer 606 may be the verified user (e.g., the user 106 of FIG. 1 as described as the employer 606 in FIG. 6). An interface may be provided to the employer 606 such that the employer 606 can use the haptic ‘slide/flick’ gesture 616 in a horizontal and/or a vertical fashion to switch a viewing pane associated with a resume 624. A response of the employer 606 being the dismiss function 608, the share function 610, the rating 612, the review function 614 and/or the interview function 618 of an applicant for the job associated with the job broadcast data 102 through the work-opportunity listing server 100 may be analyzed. A video communication 620 and/or an audio communication 622 between the employer device 505 of the employer 606 and/or another mobile device 504 of the potential job applicant may be automatically initiated through the work-opportunity listing server 100 based on the interview function 618 of the applicant for the job associated with the job broadcast data 102 through the work-opportunity listing server 100.

The job applicant and/or other job applicants may be permitted to view the rating and/or the review provided by the employer 606 for each of the potential job applicants based on a participation criteria set by the employer 606 and/or the job applicant, such that each job applicant may be able to view rating 612s and/or review 614s of each participating candidate for the job associated with the job broadcast data 102. Each job applicant for the job associated with the job broadcast data 102 may be permitted to communicate with each other.

Each job applicant may form social connections with each other based on the participation criteria set by the employer 606 and/or the job applicant (such that each job applicant may be able to form social connections with each participating candidate for the job associated with the job broadcast data 102). Participating employers in the work-opportunity listing server 100 may be permitted to see previous rating 612s, interview function 618 comments, review 614s, prescreen questions, and/or background checks across a plurality of applicants applying for a plurality jobs through the work-opportunity listing server 100 such that different employers benefit from previous diligence of at least one of previous rating 612s, interview function 618 comments, review 614s, prescreen questions, and/or background checks by participating employers with each applicant to the job that has previously applied for different jobs through the work-opportunity listing server 100.

A summary data may be provided to the employer 606 generating the job broadcast data 102 generated through the mobile device 504 of how many user profile pages were updated with an alert of the job broadcast data 102 generated through the mobile device 504 when publishing the job broadcast data 102 generated through the mobile device 504 in the private neighborhood community and/or the set of user profiles (e.g., preseeded user profiles 302 and/or claimed user profiles 304 as described in FIG. 3 having associated verified addresses (in the threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100))) based on the set of preferences of the verified user (e.g., the user 106 of FIG. 1 as described as the verified user 706 in FIG. 7).

FIG. 7 is a job broadcast view 750 that explains how a broadcasting user using the mobile device 504 creates a broadcast and manages notifications in neighborhoods that they have claimed, according to one embodiment. Particularly, FIG. 7 describes claimed geospatial locations 700 of a verified user 706 (‘Joe’), and associated information with a job broadcast generated by Joe using a broadcast indicator 702. The associated information includes a listing criteria 712, a creation time 707, a creation date 708, a time stamp 710, and an availability chart 714. The listing criteria 712 may include information about what type of job offering (e.g., ‘gardening help’, ‘car wash’) Joe is making through the work-opportunity listing server 100. The creation time 707 and creation date 708 (grouped as the time stamp 710) may indicate when the listing criteria 712 was created. The availability chart 714 may indicate times at which Joe desires assistance/help from applicants bi-directionally communicating with him through their mobile devices based on their received broadcasts.

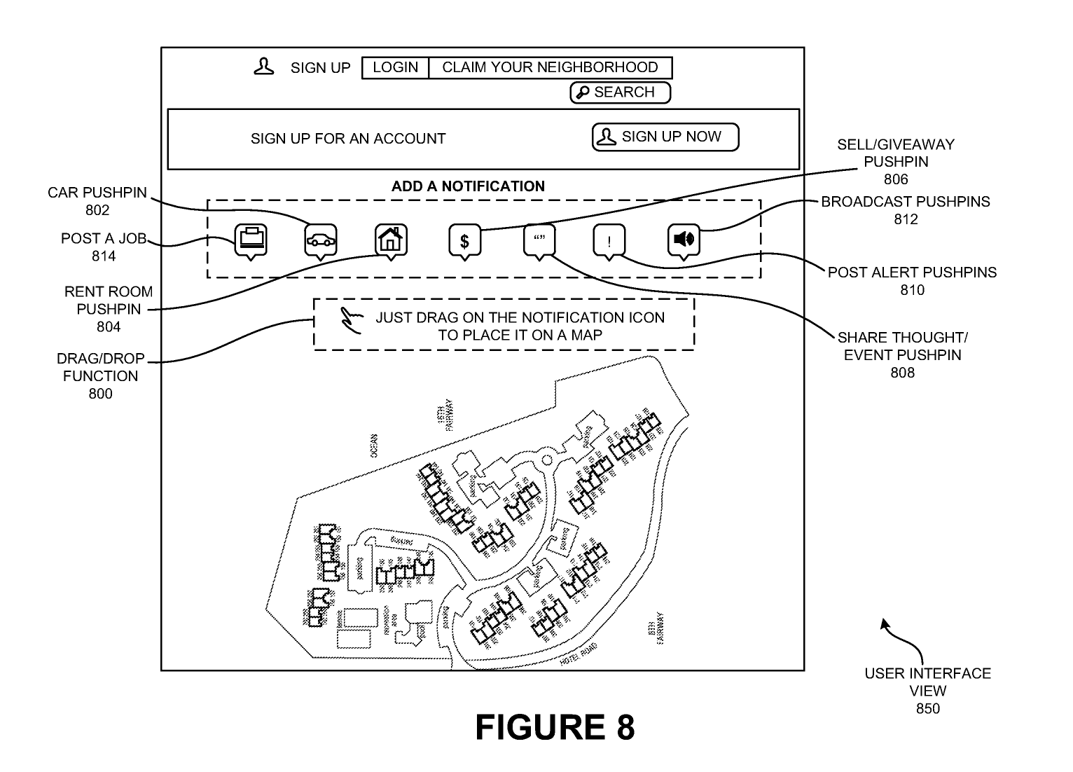

FIG. 8 is a user interface view 850 that explains how a user drags pushpins to a map including a broadcast pushpin, which is different than other pushpins in that a time and a location of the broadcast pushpin is fixed based on a set of geospatial coordinates associated with a mobile device of the broadcasting user of FIG. 7, according to one embodiment. Particularly, FIG. 8 illustrates a drag/drop function 800 associated with a car pushpin 802, a rent room pushpin 804, a sell/giveaway pushpin 806, a share thought/event pushpin 808, a post alert pushpin 810, a broadcast pushpin 812, and a post a job pushpin 814, according to one embodiment.

In FIG. 8, the broadcast pushpin 812 (e.g., that may generate the job broadcast data 102) may be unique in that it can only be placed through a device that has a geo-spatial chip and which can verify a geo-spatial location of a device making the broadcast. In this way, the broadcast pushpin 812 is fixed in time and place, whereas the other pushpins can be manually dragged to the map through the drag/drop function 800.

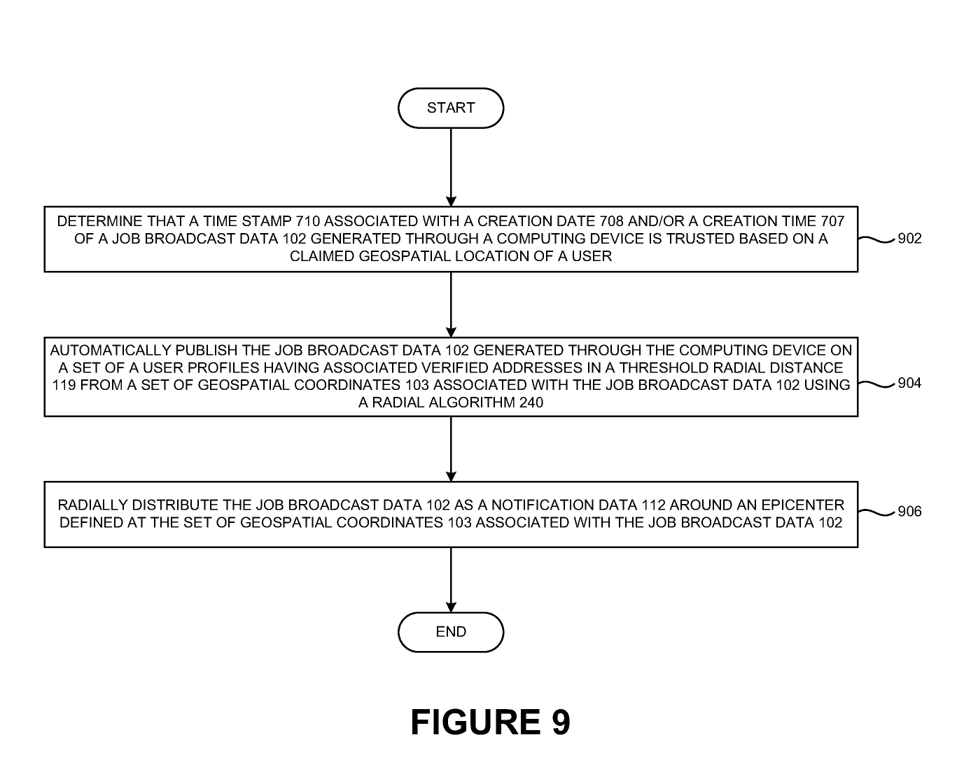

FIG. 9 is a process flow of radially distributing the job broadcast data of FIG. 3 as a notification data around an epicenter defined at the set of geospatial coordinates of FIG. 8 associated with the job broadcast data, according to one embodiment. Particularly, in FIG. 9, operation 902 may determine that a time stamp 710 associated with a creation date 708 and/or a creation time 707 of the job broadcast data 102 generated through a computing device (e.g., the device 104) is trusted based on a claimed geospatial location of a user (e.g., the user 106), according to one embodiment. Then, in operation 904, the job broadcast data 102 generated through the computing device may be automatically published on a set of user profiles having associated verified addresses in a threshold radial distance 119 from a set of geospatial coordinates 103 associated with the job broadcast data 102 using a radial algorithm 240. Next, in operation 906, the job broadcast data 102 may be radially distributed as the notification data 112 around an epicenter defined at the set of geospatial coordinates 103 associated with the job broadcast data 102.

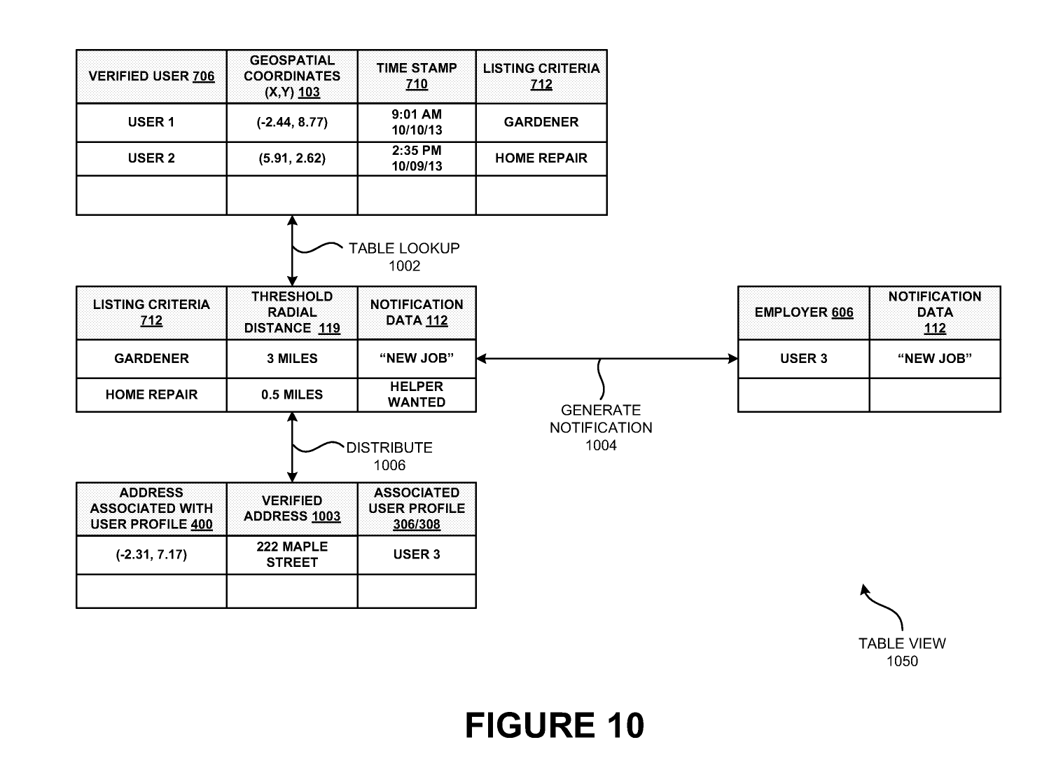

FIG. 10 is a table view 1050 illustrating data relationships between users, locations, and with a set of notification types needed to generate a broadcast, according to one embodiment. In FIG. 10, a table lookup 1002 may be performed in which a listing criteria 712 is matched with a threshold radial distance 119 and a notification data 112. Then, a notification may be generated using the generate notification operation 1004 from the employer 606, and distributed to the verified address (e.g., the verified address 1003) in the threshold radial distance 119 using the distribute operation 1006, according to one embodiment.

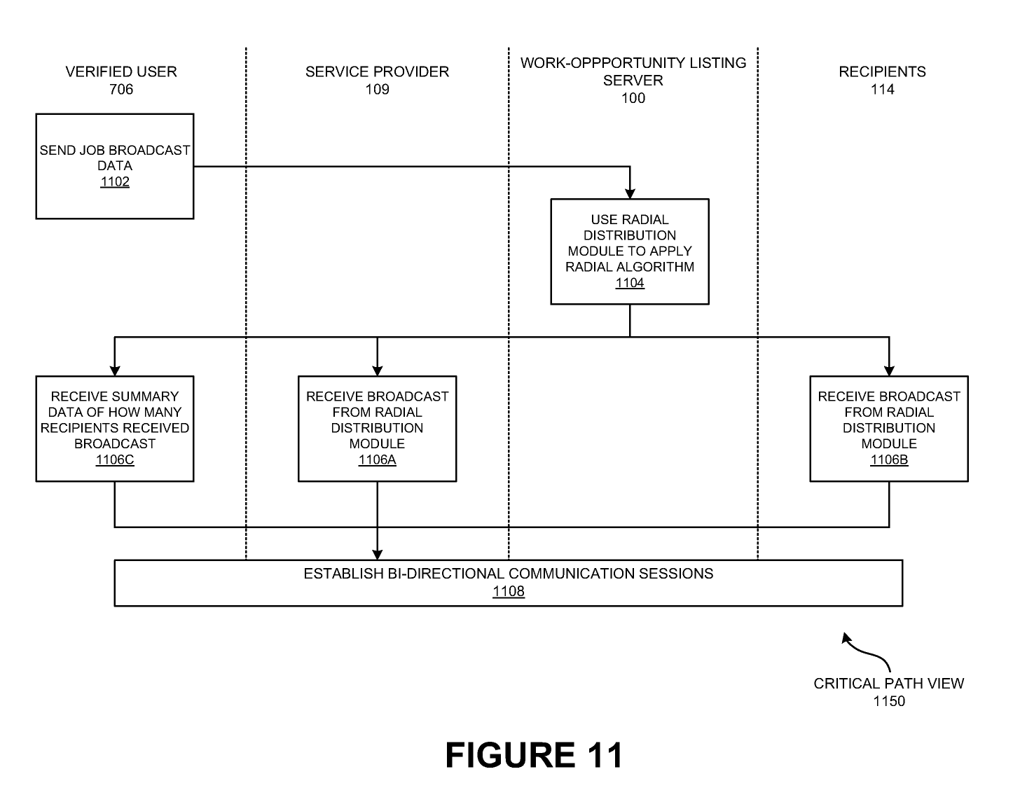

FIG. 11 is a critical path view 1150 illustrating a flow based on time in which critical operations in establishing a bi-directional session between a verified user and those individuals receiving the job broadcast data of FIG. 3 is established, according to one embodiment. In FIG. 11, a verified user 706 sends a job broadcast data 102 to the work-opportunity listing server 100 in operation 1102. Then, the service provider receives the job broadcast data 102 from the radial distribution module 140 of the work-opportunity listing server 100 in operation 1106A, according to one embodiment. Similarly, the recipients 114 receives the job broadcast data 102 from the radial distribution module 140 of the work-opportunity listing server 100 in operation 1106B, according to one embodiment. Based on operation 1106A and 1106B, the verified user 706 may automatically receive a summary of how many recipients received the job broadcast data 102 in operation 1106C. Next, bidirectional communication sessions are established between the verified user 706 and the service provider and/or the recipients 114 in operation 1108.

In one embodiment, a method of a work-opportunity listing server 100 includes validating that a job broadcast data 102 generated through a mobile device 504 is associated with a verified user (e.g., a user 106) of the work-opportunity listing server 100 using a processor 120 and a memory 124. The method verifies that a set of geospatial coordinates 103 associated with the job broadcast data 102 generated through the mobile device 504 are trusted based on a claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100). In addition, the method determines that a time stamp 710 associated with a creation date 708 and a creation time 707 of the job broadcast data 102 generated through the mobile device 504 is trusted based on the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100).

Furthermore, the job broadcast data 102 generated through the mobile device 504 is automatically published on a set of user profiles (e.g., preseeded user profiles 302 and/or claimed user profiles 304 as described in FIG. 3) having associated verified addresses in a threshold radial distance 119 from the set of geospatial coordinates 103 associated with the job broadcast data 102 generated through the mobile device 504 of the verified user (e.g., the user 106 of FIG. 1 as described as the verified user 706 in FIG. 7) of the work-opportunity listing server 100 using a radial algorithm 240. A listing criteria 712 associated with the job broadcast data 102 including a description, a photograph, a video, a salary, a fixed fee amount, an category, a functional status of a job offered through the job broadcast data 102 may be processed.

The job may be a household job, a repair job, a maintenance job, a professional job and/or a career opportunity. An availability chart 714 may be populated when the job associated with the listing criteria 712 is posted. The availability chart 714 may include a target candidate living area radius, a start timing, an hours per day, an hours per month, a professional qualification criteria and/or a timing criteria. The method may determine that the broadcast data (e.g., the job broadcast data 102) is generated by the verified user (e.g., the user 106 of FIG. 1 as described as the verified user 706 in FIG. 7) of the neighborhood broadcast system (e.g., of the geospatially constrained social network 142) when validating that the broadcast data (e.g., the job broadcast data 102) is associated with the mobile device 504.

The method may determine that an application (e.g., a downloadable application such as the Fatdoor mobile application and/or the Nextdoor mobile application) on the mobile device 504 is communicating the broadcast data (e.g., the job broadcast data 102) to the neighborhood broadcasting system when the broadcast data (e.g., the job broadcast data 102) is processed. The verified user (e.g., the user 106 of FIG. 1 as described as the verified user 706 in FIG. 7) may be associated with a verified user (e.g., the user 106 of FIG. 1 as described as the verified user 706 in FIG. 7) profile in the neighborhood broadcasting system through the application on the mobile device 504. The job broadcast data 102 generated through the mobile device 504 may be presented as a job alert pushpin of the job broadcast in a geospatial map surrounding pre-populated residential and/or business listings in a surrounding vicinity (such that the job alert pushpin of the job broadcast may be automatically presented on the geospatial map in addition to being presented on the set of user profiles (e.g., preseeded user profiles 302 and/or claimed user profiles 304 as described in FIG. 3 having associated verified addresses in the threshold radial distance 119 from the set of geospatial coordinates 103 associated with the job broadcast data 102 generated through the mobile device 504 of the verified user (e.g., the user 106 of FIG. 1 as described as the verified user 706 in FIG. 7) of the work-opportunity listing server 100)).

The job broadcast data 102 generated through the mobile device 504 may be radially distributed through an on-page posting, an electronic communication, and/or a push notification (delivered to desktop and/or mobile device 504s). The job broadcast data 102 may be associated with users and/or their user profiles (e.g., preseeded user profiles 302 and/or claimed user profiles 304 as described in FIG. 3 around an epicenter defined at the set of geospatial coordinates 103 associated with the job broadcast data 102. The job broadcast data 102 may be generated through the mobile device 504 to all subscribed user profiles (e.g., preseeded user profiles 302 and/or claimed user profiles 304 as described in FIG. 3 in a circular geo-fenced area defined by the threshold distance from the set of geospatial coordinates 103 associated with the job broadcast data 102. Furthermore, the job broadcast data 102 may be generated through the mobile device 504 through the radial algorithm 240 of a neighborhood broadcasting system that measures a distance away of each address associated with each user profile from the current geospatial location at the epicenter.

The verified user (e.g., the user 106 of FIG. 1 as described as the verified user 706 in FIG. 7) may be permitted to drag and/or drop the job alert pushpin on any location on the geospatial map, and/or automatically determining a latitude and/or a longitude associated with a placed location. A career center 309A, a hardware store 309B, a professional service provider 309C, a landscaper 309D, a gardener 309E, a plumber 309F, a handyman 309G, and/or a homeless shelter 309H in a surrounding geospatial area to the set of geospatial coordinates 103 associated with the job broadcast data 102 generated through the mobile device 504 may be automatically notified. The geospatial coordinates 103 may be extracted from a metadata associated with the job broadcast data 102 generated through the mobile device 504 when verifying that the set of geospatial coordinates 103 associated with the job broadcast data 102 generated through the mobile device 504 are trusted based on the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100). A relative match between a persistent clock associated with the work-opportunity listing server 100 and/or a digital clock of the mobile device 504 may determine that the time stamp 710 associated with the creation date 708 and/or time of the job broadcast data 102 generated through the mobile device 504 is accurate and therefore trusted.

A publishing of the job broadcast data 102 generated through the mobile device 504 on a set of user profiles (e.g., preseeded user profiles 302 and/or claimed user profiles 304 as described in FIG. 3 having associated verified addresses in the threshold radial distance 119 from the set of geospatial coordinates 103 associated with the job broadcast data 102 generated through the mobile device 504 of the verified user (e.g., the user 106 of FIG. 1 as described as the verified user 706 in FIG. 7) of the work-opportunity listing server 100) may be automatically deleted based on a job alert expiration time. A set of residential addresses each associated with a resident name in a neighborhood surrounding the mobile device 504 may be geocoded. The method may prepopulate the set of residential addresses (each associated with the resident name) as the set of user profiles (e.g., preseeded user profiles 302 and/or claimed user profiles 304 as described in FIG. 3 in the threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100) in a neighborhood curation system (e.g., part of the geospatially constrained social network 142) communicatively coupled with the work-opportunity listing server 100. The method may permit the verified user (e.g., the user 106 of FIG. 1 as described as the verified user 706 in FIG. 7) to modify content in each of the set of user profiles (e.g., preseeded user profiles 302 and/or claimed user profiles 304 as described in FIG. 3. The modified content may be tracked through the neighborhood curation system (e.g., part of the geospatially constrained social network 142).

A reversible history journal associated with each of the set of user profiles (e.g., preseeded user profiles 302 and/or claimed user profiles 304 as described in FIG. 3 such that a modification of the verified user (e.g., the user 106 of FIG. 1 as described as the verified user 706 in FIG. 7) can be undone on a modified user profile page may be generated. An editing credibility of the verified user (e.g., the user 106 of FIG. 1 as described as the verified user 706 in FIG. 7) based on an edit history of the verified user (e.g., the user 106 of FIG. 1 as described as the verified user 706 in FIG. 7) and/or a community contribution validation of the verified user (e.g., the user 106 of FIG. 1 as described as the verified user 706 in FIG. 7) by other users of the neighborhood curation system (e.g., part of the geo spatially constrained social network 142) may be determined. The job broadcast data 102 generated through the mobile device 504 to a set of user profiles (e.g., preseeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100) using the radial algorithm 240 may be automatically published. A claim request of the verified user (e.g., the user 106 of FIG. 1 as described as the verified user 706 in FIG. 7) generating the job broadcast data 102 generated through the mobile device 504 to be associated with an address of the neighborhood curation system (e.g., part of the geospatially constrained social network 142) may be processed.

It may be determined if the claimable neighborhood in the neighborhood curation system (e.g., part of the geospatially constrained social network 142) is associated with a private neighborhood community in the claimable neighborhood of the neighborhood curation system (e.g., part of the geo spatially constrained social network 142). The verified user (e.g., the user 106 of FIG. 1 as described as the verified user 706 in FIG. 7) may be associated with the private neighborhood community in the claimable neighborhood of the neighborhood curation system (e.g., part of the geospatially constrained social network 142) if the private neighborhood community has been activated by the verified user (e.g., the user 106 of FIG. 1 as described as the verified user 706 in FIG. 7) and/or a different verified user (e.g., the user 106 of FIG. 1 as described as the verified user 706 in FIG. 7). The verified user (e.g., the user 106 of FIG. 1 as described as the verified user 706 in FIG. 7) may be permitted to draw a set of boundary lines in a form of a geospatial polygon such that the claimable neighborhood in a geospatial region surrounding the claim request creates the private neighborhood community in the neighborhood curation system (e.g., part of the geospatially constrained social network 142) if the private neighborhood community may be inactive.

The method may verify the claim request of the verified user (e.g., the user 106 of FIG. 1 as described as the verified user 706 in FIG. 7) generating the job broadcast data 102 generated through the mobile device 504 to be associated with a neighborhood address of the neighborhood curation system (e.g., part of the geospatially constrained social network 142) when the address may be determined to be associated with a work address and/or a residential address of the verified user (e.g., the user 106 of FIG. 1 as described as the verified user 706 in FIG. 7). The job broadcast data 102 generated through the mobile device 504 on the private neighborhood community associated with the verified user (e.g., the user 106 of FIG. 1 as described as the verified user 706 in FIG. 7) generating the job broadcast data 102 generated through the mobile device 504 may be simultaneously published through the mobile device 504 in the threshold radial distance 119 from the address associated with the claim request of the verified user (e.g., the user 106 of FIG. 1 as described as the verified user 706 in FIG. 7) of the neighborhood curation system (e.g., part of the geospatially constrained social network 142) (when automatically publishing the job broadcast data 102 generated through the mobile device 504 on a set of user profiles (e.g., preseeded user profiles 302 and/or claimed user profiles 304 as described in FIG. 3 having associated verified addresses) in a threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the work-opportunity listing server 100) based on a set of preferences of the verified user (e.g., the user 106 of FIG. 1 as described as the verified user 706 in FIG. 7) using the radial algorithm 240.

The job broadcast data 102 generated through the mobile device 504 may be live broadcasted to the different verified user (e.g., the user 106 of FIG. 1 as described as the verified user 706 in FIG. 7) and/or other verified user (e.g., the user 106 of FIG. 1 as described as the verified user 706 in FIG. 7) in the private neighborhood community and/or currently within the threshold radial distance 119 from the current geospatial location through the work-opportunity listing server 100 through a multicast algorithm such that a live broadcast multicasts to a plurality of data processing systems associated with each of the different user and/or the other verified user (e.g., the user 106 of FIG. 1 as described as the verified user 706 in FIG. 7) simultaneously when the mobile device 504 of the verified user (e.g., the user 106 of FIG. 1 as described as the verified user 706 in FIG. 7) generating the live-broadcast enables broadcasting of the job broadcast data 102 generated through the mobile device 504 to any one of a geospatial vicinity around the mobile device 504 of the verified user (e.g., the user 106 of FIG. 1 as described as the verified user 706 in FIG. 7) generating the broadcast and/or in any private neighborhood community in which the verified user (e.g., the user 106 of FIG. 1 as described as the verified user 706 in FIG. 7) has a non-transitory connection.

The different verified user (e.g., the user 106 of FIG. 1 as described as the verified user 706 in FIG. 7) and/or other verified user (e.g., the user 106 of FIG. 1 as described as the verified user 706 in FIG. 7) in the private neighborhood community may be permitted to bi-directionally communicate with the verified user (e.g., the user 106 of FIG. 1 as described as the verified user 706 in FIG. 7) generating the broadcast through the work-opportunity listing server 100. Any private neighborhood community in which the verified user (e.g., the user 106 of FIG. 1 as described as the verified user 706 in FIG. 7) has a non-transitory connection may be a residential address of the verified user (e.g., the user 106 of FIG. 1 as described as the verified user 706 in FIG. 7) and/or a work address of the verified user (e.g., the user 106 of FIG. 1 as described as the verified user 706 in FIG. 7) that has been confirmed by the work-opportunity listing server 100 as being associated with the verified user (e.g., the user 106 of FIG. 1 as described as the verified user 706 in FIG. 7). The threshold distance may be between 0.2 and/or 0.4 miles from the set of geospatial coordinates 103 associated with the job broadcast data 102 generated through the mobile device 504 to optimize a relevancy of the live-broadcast.

The work-opportunity listing server 100 may include a crowdsourced moderation algorithm in which multiple neighbors to a geospatial area determine what content contributed to the work-opportunity listing server 100 persists and/or which may be deleted. The work-opportunity listing server 100 may permit users to mute messages of specific verified user (e.g., the user 106 of FIG. 1 as described as the verified user 706 in FIG. 7) to prevent misuse of the work-opportunity listing server 100. All subscribed user profiles (e.g., preseeded user profiles 302 and/or claimed user profiles 304 as described in FIG. 3 in a circular geo-fenced area may be defined by the threshold distance from the set of geospatial coordinates 103 associated with the job broadcast data 102 generated through the computing device through the radial algorithm 240 of a neighborhood broadcasting system that measures a distance away of each address associated with each user profile from the current geospatial location at the epicenter.

In another embodiment, a method of a work-opportunity listing server 100 includes determining that a time stamp 710 associated with a creation date 708 and/or a creation time 707 of a job broadcast data 102 generated through a computing device is trusted based on a claimed geospatial location (e.g., any of the claimed geo spatial locations 700 as described in FIG. 7 of a user of the work-opportunity listing server 100 using a processor 120 and a memory 124. The method includes automatically publishing the job broadcast data 102 generated through the computing device on a set of user profiles (e.g., preseeded user profiles 302 and/or claimed user profiles 304 as described in FIG. 3 having associated verified addresses in a threshold radial distance 119 from a set of geospatial coordinates 103 associated with the job broadcast data 102 generated through the computing device of the user of the work-opportunity listing server 100 using a radial algorithm 240.

In addition, the method includes radially distributing the job broadcast data 102 as a notification data through an on-page posting, an electronic communication, and/or a push notification delivered to either (1) a set of recipients through an internet protocol (IP) based network associated with users and/or their user profiles (e.g., preseeded user profiles 302 and/or claimed user profiles 304 as described in FIG. 3 around an epicenter defined at the set of geospatial coordinates 103 associated with the job broadcast data 102 generated through the computing device or (2) a set of service providers accessible by the work opportunity server through a cellular network using the radial algorithm 240 in addition to the set of recipients through the IP based network associated with users and/or their user profiles (e.g., preseeded user profiles 302 and/or claimed user profiles 304 as described in FIG. 3.

In yet another embodiment, a system includes a work opportunity server to automatically publish a job broadcast data 102 on a set of user profiles (e.g., preseeded user profiles 302 and/or claimed user profiles 304 as described in FIG. 3 having associated verified addresses in a threshold radial distance 119 from the set of geospatial coordinates 103 associated with the job broadcast data 102 of a verified user (e.g., the user 106 of FIG. 1 as described as the verified user 706 in FIG. 7) of the work-opportunity listing server 100) using a radial algorithm 240. The system also includes a mobile device 504 communicatively coupled with the work opportunity server through a network to generate the job broadcast data 102 using a camera, a microphone, and/or a sensory capability of the mobile device 504 to generate a captured data that is appended with a present geospatial location and/or a time stamp 710 associated with a creation date 708 and/or a creation time 707 of the captured data in generating the job broadcast data 102.

Embodiments described herein in FIGS. 1-11 govern a new kind of social network for neighborhoods, according to one embodiment (e.g., may be private and/or wiki-editable search engine based). It should be noted that in some embodiments, the address of an user may be masked from the public search (but still may be used for privacy considerations), according to one embodiment. Some embodiments have no preseeded data, whereas others might. Embodiments described herein may present rich, location specific information on individual residents and businesses.

A user can “Claim” one or more Business Pages and/or a Residential Pages, according to one embodiment. In order to secure their Claim, the user may verify their location associated with the Business Page and/or Residential page within 30 days, or the page becomes released to the community, according to one embodiment. A user can only have a maximum of 3 unverified Claims out at any given time, according to one embodiment. When a user clicks on “Claim this Page” on Business Profile page and/or a Residential Profile page, they can indicate the manner in which they intend to verify their claim, according to one embodiment. Benefits of Claiming a Business Page and/or Residential page may enable the user to mark their page ‘Self-Editable only’ from the default ‘Fully Editable’ status, and see “Private” listings in a claimed neighborhood around the verified location, according to one embodiment. Each edit by a user on a Residential Profile page and/or a Business Profile page may be made visible on the profile page, along with a date stamp, according to one embodiment.

Browse function: Based on the user's current location, the browse function may display a local map populated with pushpins for location-specific information, and a news feed, made up of business page edits, public people page edits, any recent broadcasts, etc., according to one embodiment. The news feed may show up on each Business Page and each Residential Page, based on activity in the surrounding area, according to one embodiment. Secure a Neighborhood function: May allow the user to identify and “secure” a neighborhood, restricting certain types of access to verified residents, according to one embodiment. Add a Pushpin function: May allow any registered or verified user to add any type of Pushpin (as described in FIG. 8), to one embodiment.

In addition to the map, the search results page may display a news feed, made up of business page edits, public people page edits, any recent broadcasts, and autogenerated alerts who has moved into the neighborhood, who has moved out of the neighborhood, any recent reviews in the neighborhood, any pushpins placed in the immediate area, etc., according to one embodiment. The news feed may prioritize entries relating to the search results, and will take into account privacy policies and preferences, according to one embodiment.

Example Newsfeeds may include:

Joe Smith moved into the neighborhood in September 2013. Welcome Joe! Like Share; 43 neighbors (hyperlink) moved in to the Cupertino library neighborhood in July 2013. Like Share; 12 neighbors (hyperlink) verified in to the Cupertino library neighborhood in July 2013. Like Share; Raj Abhyanker, invited Paul Smith, a guest to the Cupertino neighborhood. Raj indicates Paul is a friend from college looking to move into the neighborhood. Welcome Paul!; Raj Abhyanker posted a Nissan Leaf for rent $35 a day, in mountain view Rent now. Like Share

This content may feed each Profile Page and helps to increase Search Engine value for content on the site, according to one embodiment. Alerts may be created and curated (prioritized, filtered) automatically and/or through crowdsourcing, to keep each page vibrant and actively updating on a regular basis (ideally once a day or more), according to one embodiment.

A Multi-Family Residence page will display a list of residents in the entire building, according to one embodiment. Clicking on any resident will display a Single Family Residence page corresponding to the individual living unit where that person resides, according to one embodiment.

For example, suppose that John Smith and Jane Smith live in apartment 12 of a large building. Their names are included in the list of residents. When a user clicks on either John Smith or Jane Smith, we will display a “Single Family Residence” page showing both John and Jane, just as if apartment 12 was a separate structure, according to one embodiment.

The broadcast feature (e.g., associated with the job broadcast data 102 and generated by the radial algorithm 240 of the radial distribution module 140) may be a “Radio” like function that uses the mobile device's current geospatial location to send out information to neighbors around the present geospatial location of the user, according to one embodiment. Broadcasts may be posted to neighbor pages in the geospatial vicinity (e.g., in the same neighborhood) on public and private pages in the geospatial social network, according to one embodiment. These broadcasts may enable any user, whether they live in a neighborhood or not to communicate their thoughts to those that live or work (or have claimed) a profile in the neighborhood around where the broadcaster is physically at, regardless of where the broadcaster lives, according to one embodiment. Broadcasts can be audio, video, pictures, and or text, according to one embodiment. For accountability, the broadcaster may be a verified user and their identity made public to all users who receive the broadcast in one embodiment.

This means that the broadcast feature may be restricted to be used only by devices (E.g., mobile phones) that have a GPS chip (or other geolocation device) that an identify a present location of where the broadcast is originating from, according to one embodiment. The broadcast may be sent to all users who have claimed a profile in the geospatial vicinity where the broadcast originates, according to one embodiment. This can either be broadcast live to whoever is “tuned” in to a broadcast of video, audio, picture, and text in their neighborhood, or can be posted on each users profile if they do not hear the broadcast to the neighborhood in a live mode in one embodiment.

When a broadcast is made neighbors, around where the broadcast is made, they may receive a message that says something like:

Raj Abhyanker, a user in Menlo Park just broadcast “Japanese cultural program” video from the Cupertino Union church just now. Watch, Listen, View

This broadcast may be shared with neighbors around Menlo park, and or in Cupertino. This way, Raj's neighbors and those in Cupertino can know what is happening in their neighborhoods, according to one embodiment. In one embodiment, the broadcast only goes to one area (Cupertino or Menlo park in the example above).

Broadcasts could be constrained to devices that have geospatial accuracy of present location and a current only (mobile devices for example). Otherwise, broadcasts won't mean much, according to one embodiment (would otherwise be just like thoughts/video upload without this). Broadcasts shouldn't be confused with ‘upload videos’, according to one embodiment. Different concepts. Why? Broadcasts have an accuracy of time and location that cannot be altered by a user, according to one embodiment, Hence, mobile is the most likely medium for this not desktop computer, according to one embodiment. We should not let the user set their own location for broadcasts (like other pushpin types), according to one embodiment. Also time is fixed, according to one embodiment. Fixing and not making these two variables editable give users confidence that the broadcast was associated with a particular time and place, and creates a very unique feature, according to one embodiment. For example, it would be not useful if the broadcast is untrusted as to location of origination, according to one embodiment. E.g., I broadcast when I am somewhere only about the location I am at, according to one embodiment.

Broadcasts are different that other pushpins because location of where a broadcast, and time of broadcast is

*current location* and *current time*, according to one embodiment. They are initiated wherever a broadcaster is presently at, and added to the news feed in the broadcasters neighborhood and in the area wherever a broadcaster is presently at, according to one embodiment.

Broadcast rules may include:

1. If I post a Broadcast in my secured neighborhood, only my neighbors can see it, according to one embodiment.

2. If I post a Broadcast in different secured neighborhood then my own, my neighbors can see it (e.g., unless I turn this off in my privacy setting) and neighbors in the secured neighborhood can see it (e.g., default not turn-offable, but I can delete my broadcast), according to one embodiment.

3. If I post a Broadcast in different unsecured neighborhood then my own, my neighbors can see it (unless I turn this off in my privacy setting) and the broadcast is publicly visible on user pages of public user profiles in the unsecured neighborhood until profiles are claimed and/or the neighborhood is secured, according to one embodiment.

4. If an outsider in a secure neighborhood posts a broadcast in my secure neighborhood, it's not public, according to one embodiment.

5. If an outsider in a unsecure neighborhood posts a broadcast in my secure neighborhood, the system does not post on profiles in his unsecure neighborhood (to prevent stalking, burglary), but does post in my secure neighborhood, according to one embodiment.

Privacy settings. For each verified residential or business location, the user may set Privacy to Default, Public, Private, or Inactive, according to one embodiment. The Default setting (which is the default) means that the profile will be public, until the neighborhood is secured; in a secured neighborhood, the profile will be Private, according to one embodiment. By changing this setting, the user may force the profile to be Public or Private, regardless of whether the neighborhood is secured, according to one embodiment.

For each verified residential location, the user may set edit access to Group Editable or Self Editable, according to one embodiment.

Residential Privacy example. The residential profiles can be: Public: anyone can search, browse, or view the user profile, according to one embodiment. This is the default setting for unsecured neighborhoods (initially, all the content on the site), according to one embodiment. Private: only people in my neighborhood can search, browse, or view the user's profile, according to one embodiment. This is the default for secured neighborhoods, according to one embodiment. Inactive: nobody can search, browse, or view the profile, even within a secured neighborhood, according to one embodiment. A user may have at least one active (public or private), verified profile in order to have edit capabilities, according to one embodiment; if the user makes all profiles inactive, that user is treated (for edit purposes) as an unverified user, according to one embodiment.

Verified users can edit the privacy setting for their profile and override the default, according to one embodiment. Group Editable: anyone with access to a profile based on the privacy roles above can edit the profile, according to one embodiment This is the default setting, according to one embodiment Self Editable, only the verified owner of a profile can edit that profile, according to one embodiment.

Exceptions Guest User. A verified user in another neighborhood is given “Guest” access to a neighborhood for a maximum of 60 days by a verified user in the neighborhood in which the guest access is given, according to one embodiment. In effect, the guest becomes a member of the neighborhood for a limited period, according to one embodiment. Friend. When a user has self-elected being friends with someone in a different neighborhood, they can view each other's profiles only (not their neighbors), according to one embodiment. One way for a user to verify a location is to submit a scanned utility bill, according to one embodiment.

When a moderator selects the Verify Utility Bills function, the screen will display a list of items for processing, according to one embodiment. Accept the utility bill as a means of verification, according to one embodiment. This will verify the user's location, and will also generate an e-mail to the user, according to one embodiment. Or Decline the utility bill as a means of verification, according to one embodiment. There will be a drop-down list to allow the moderator to select a reason, according to one embodiment; this reason will be included in an e-mail message to the user. Reasons may include: Name does not match, address does not match, name/address can't be read, not a valid utility bill, according to one embodiment.

An example embodiment will now be described. An employer (e.g., an organization, a non-profit institution, a home owner, a tenant, a manager) may post a work opportunity (e.g., a job listing, a task, a career opportunity) on a geospatially constrained social network (e.g., Fatdoor.com, Nextdoor.com). The employer may receive applications from candidates responding to the work opportunity based on a job broadcast data 102 that they broadcast (e.g., post using the radial algorithm 240) using a desktop computer at their work address and/or through their mobile device. The employer may be able to recruit, manage, and pay filtered candidates who send applications from a geospatial vicinity of where the employer is looking to hire someone. The employer may be looking for someone for a permanent job opening from a neighborhood around the office of the employer and/or maybe looking for temporary help. Applications may be received from active and passive candidates who may be ideally suited for the work opportunity because they live close by and have desired skills

In some cases, a preferred applicant may already be employed and may receive the job broadcast data 102 through their mobile device (e.g., even when their mobile device is physically at a different location than a location in which they live). The preferred applicant may be become aware of the work opportunity as a result of their participation through the geospatially constrained social network 142 having the work-opportunity listing server 100. Therefore, the preferred applicant may discover an option to apply for the work opportunity when the work opportunity is in a location geographically proximate to an address where the preferred candidate has a non-transitory association (e.g., an existing home address, an existing work address).

Sometimes, the preferred applicant may wish to pursue the work opportunity despite being already employed when the work opportunity is presented to them because of geospatial proximity of the work opportunity to the non-transitory location(s) associated with preferred candidate. Because the preferred candidate may be presented with the work opportunity through the embodiments of described in FIGS. 1-11 using the radial algorithm 240 of the radial distribution module 140 of the work-opportunity listing server 100, the employer may have a chance to interview and/or hire the preferred candidate. Therefore, employer may save money in hiring, training and ultimately succeeding with an optimal candidate (e.g., a candidate who lives close by and possesses desired skills)

For example, an employer Bob Jones may post a work opportunity for a handyman to assist with a Fence Repair project for his home in the Portrero Hill neighborhood on Nextdoor.com (or Fatdoor.com). Bob Jones may receive applications from candidates responding to the work opportunity based on a job broadcast data 102 that they broadcast (e.g., post using the radial algorithm 240) using a desktop computer at their work address and/or through their mobile device. Bob Jones may be able to recruit, manage, and pay filtered candidates who send applications from Portero Hill and/or from the adjacent SOMA neighborhood of San Francisco, both nearby areas of where the Bob Jones is looking to hire someone. Bob Jones may be looking for someone for a permanent job opening from a neighborhood for an Engineer opening around his SOMA office and/or maybe looking for temporary help for a computer repair job at his home in Portero Hill. Applications may be received from active job seekers living in Portrero Hill (and/or SOMA) neighborhood and passive candidates who are currently employed may be ideally suited for the work opportunity because they live close by and have desired skills

In some cases, a preferred applicant Jane Smith, a resident of Portero Hill, may already be employed and may receive the job broadcast data 102 through her mobile device (e.g., even when Jane and her mobile device is physically at work 60 miles away in Santa Cruz). Jane may hate the commute each day to Santa Cruz, and may be open to working for Bob Jones given the difficulty in getting to work. Jane may have the perfect skills that Bob is looking for. Jane may be become aware of the Engineer opening as a result of her participation through the geographically constrained social network Nextdoor.com or Fatdoor.com. Therefore, Jane may discover an option to apply for Bob's job opening (or any other openings around her home) when they are broadcast from a location geographically proximate to an address to her home in Portrero Hill.

Because Jane may be presented with the work opportunity through the embodiments of described in FIGS. 1-11, Bob may have a chance to interview and/or hire Jane, the preferred candidate, even though she was already employed. Therefore, employer may save money in hiring, training and ultimately succeeding with an optimal candidate (e.g., a candidate who lives close by and possesses desired skills)

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system. Accordingly, the specification and drawings are to be regarded in an illustrative rather than a restrictive sense.

What is claimed is:

1. A method of a work-opportunity listing server comprising:
validating that a job broadcast data generated through a mobile device is associated with a verified user of the work-opportunity listing server using a processor and a memory;
verifying that a set of geospatial coordinates associated with the job broadcast data generated through the mobile device are trusted based on a claimed geospatial location of the verified user of the work-opportunity listing server;
determining that a time stamp associated with a creation date and a creation time of the job broadcast data generated through the mobile device is trusted based on the claimed geospatial location of the verified user of the work-opportunity listing server; and
automatically publishing the job broadcast data generated through the mobile device on a set of user profiles having associated verified addresses in a threshold radial distance from the set of geospatial coordinates associated with the job broadcast data generated through the mobile device of the verified user of the work-opportunity listing server using a radial algorithm.

2. The method of claim 1 further comprising:
processing at least one of a listing criteria associated with the job broadcast data comprising a description, a photograph, a video, a salary, a fixed fee amount, an category, a functional status of a job offered through the job broadcast data, wherein the job is at least one of a household job, a repair job, a maintenance job, a professional job and a career opportunity;
populating an availability chart when the job associated with the listing criteria is posted, wherein the availability chart includes at least one of an target candidate living area radius, a start timing, an hours per day, an hours per month, a professional qualification criteria and a timing criteria;
determining that the broadcast data is generated by the verified user of the neighborhood broadcast system when validating that the broadcast data is associated with the mobile device;
determining that an application on the mobile device is communicating the broadcast data to the neighborhood broadcasting system when the broadcast data is processed; and
associating the verified user with a verified user profile in the neighborhood broadcasting system through the application on the mobile device,
presenting the job broadcast data generated through the mobile device as a job alert pushpin of the job broadcast in a geospatial map surrounding pre-populated residential and business listings in a surrounding vicinity, such that the job alert pushpin of the job broadcast is automatically presented on the geospatial map in addition to being presented on the set of user profiles having associated verified addresses in the threshold radial distance from the set of geospatial coordinates associated with the job broadcast data generated through the mobile device of the verified user of the work-opportunity listing server,
wherein the job broadcast data generated through the mobile device is radially distributed through at least one of an on-page posting, an electronic communication, and a push notification delivered to desktop and mobile devices associated with users and their user profiles around an epicenter defined at the set of geospatial coordinates associated with the job broadcast data generated through the mobile device to all subscribed user profiles in a circular geo-fenced area defined by the threshold distance from the set of geospatial coordinates associated with the job broadcast data generated through the mobile device through the radial algorithm of a neighborhood broadcasting system that measures a distance away of each address associated with each user profile from the current geospatial location at the epicenter.

3. The method of claim 2 further comprising:
permitting the verified user to drag and drop the job alert pushpin on any location on the geospatial map, and automatically determining a latitude and a longitude associated a placed location; and
automatically notifying at least one of a career center, a hardware store, a professional services provider, a landscaper, a gardener, a plumber, a handyman, and a homeless shelter in a surrounding geospatial area to the set of geospatial coordinates associated with the job broadcast data generated through the mobile device.

4. The method of claim 3 further comprising:
extracting the geospatial coordinates from a metadata associated with the job broadcast data generated through the mobile device when verifying that the set of geospatial coordinates associated with the job broadcast data generated through the mobile device are trusted based on the claimed geospatial location of the verified user of the work-opportunity listing server.

5. The method of claim 4 further comprising:
determining a relative match between a persistent clock associated with the work-opportunity listing server and a digital clock of the mobile device to determine that the time stamp associated with the creation date and time of the job broadcast data generated through the mobile device is accurate and therefore trusted; and
automatically deleting the a publishing the job broadcast data generated through the mobile device on a set of user profiles having associated verified addresses in the threshold radial distance from the set of geospatial coordinates associated with the job broadcast data generated through the mobile device of the verified user of the work-opportunity listing server based on a job alert expiration time.

6. The method of claim 5 further comprising:
geocoding a set of residential addresses each associated with a resident name in a neighborhood surrounding the mobile device; and
prepopulating the set of residential addresses each associated with the resident name as the set of user profiles in the threshold radial distance from the claimed geospatial location of the verified user of the work-opportunity listing server in a neighborhood curation system communicatively coupled with the work-opportunity listing server.

7. The method of claim 6 further comprising:
permitting the verified user to modify content in each of the set of user profiles;
tracking the modified content through the neighborhood curation system;
generating a reversible history journal associated with each of the set of user profiles such that a modification of the verified user can be undone on a modified user profile page;
determining an editing credibility of the verified user based on an edit history of the verified user and a community contribution validation of the verified user by other users of the neighborhood curation system; and
automatically publishing the job broadcast data generated through the mobile device to a set of user profiles having associated verified addresses in a threshold radial distance from the claimed geospatial location of the verified user of the work-opportunity listing server using the radial algorithm.

8. The method of claim 7 further comprising:
processing a claim request of the verified user generating the job broadcast data generated through the mobile device through the mobile device to be associated with an address of the neighborhood curation system;
determining if the claimable neighborhood in the neighborhood curation system is associated with a private neighborhood community in the claimable neighborhood of the neighborhood curation system;
associating the verified user with the private neighborhood community in the claimable neighborhood of the neighborhood curation system if the private neighborhood community has been activated by at least one of the verified user and a different verified user;
permitting the verified user to draw a set of boundary lines in a form of a geospatial polygon such that the claimable neighborhood in a geospatial region surrounding the claim request creates the private neighborhood community in the neighborhood curation system if the private neighborhood community is inactive;
verifying the claim request of the verified user generating the job broadcast data generated through the mobile device through the mobile device to be associated with a neighborhood address of the neighborhood curation system when the address is determined to be associated with at least one of a work address and a residential address of the verified user; and
simultaneously publishing the job broadcast data generated through the mobile device on the private neighborhood community associated with the verified user generating the job broadcast data generated through the mobile device through the mobile device in the threshold radial distance from the address associated with the claim request of the verified user of the neighborhood curation system when automatically publishing the job broadcast data generated through the mobile device on a set of user profiles having associated verified addresses in a threshold radial distance from the claimed geospatial location of the verified user of the work-opportunity listing server based on a set of preferences of the verified user using the radial algorithm.

9. The method of claim 8 further comprising:
automatically downloading a set of resumes to the mobile device, wherein an employer is the verified user;
providing an interface to the employer such that the employer can use a haptic ‘flick’ gesture in at least one of a horizontal and a vertical fashion to switch a viewing pane associated with a resume;
analyzing a response of the employer being at least one a dismiss, a save, a rating, a review and an interview of an applicant for the job associated with the job broadcast data through the work-opportunity listing server;
automatically initiating at least one of a video communication and an audio communication between the mobile device of the employer and another mobile device the potential job applicant through the work-opportunity listing server based on the interview of the applicant for the job associated with the job broadcast data through the work-opportunity listing server;
permitting the job applicant and other job applicants to view at least one of the rating and the review provided by the employer for each of the potential job applicants based on a participation criteria set by at least one of the employer and the job applicant, such that each job applicant is able to view ratings and reviews of each participating candidate for the job associated with the job broadcast data;
permitting each job applicant for the job associated with the job broadcast data to communicate with each other and form social connections with each other based on the participation criteria set by at least one of the employer and the job applicant, such that each job applicant is able to form social connections with each participating candidate for the job associated with the job broadcast data;
permitting participating employers in the work-opportunity listing server to see at least one of previous ratings, interview comments, reviews, prescreen questions, and background checks of across a plurality of applicants applying for a plurality jobs through the work-opportunity listing server such that different employers benefit from previous diligence of at one of previous ratings, interview comments, reviews, prescreen questions, and background checks by participating employers with each applicant to the job that has previously applied for different jobs through the work-opportunity listing server; and
providing a summary data to the employer generating the job broadcast data generated through the mobile device through the mobile device of how many user profile pages were updated with an alert of the job broadcast data generated through the mobile device when publishing the job broadcast data generated through the mobile device in at least one of the private neighborhood community and the set of user profiles having associated verified addresses in the threshold radial distance from the claimed geospatial location of the verified user of the work-opportunity listing server based on the set of preferences of the verified user.

10. The method of claim 9 further comprising:
live broadcasting the job broadcast data generated through the mobile device to the different verified user and other verified users in at least one of the private neighborhood community and currently within the threshold radial distance from the current geospatial location through the work-opportunity listing server through a multicast algorithm such that a live broadcast multicasts to a plurality of data processing systems associated with each of the different user and the other verified users simultaneously when the mobile device of the verified user generating the live-broadcast enables broadcasting of the job broadcast data generated through the mobile device to any one of a geospatial vicinity around the mobile device of the verified user generating the broadcast and in any private neighborhood community in which the verified user has a non-transitory connection; and
permitting the different verified user and other verified users in at least one of the private neighborhood community to bi-directionally communicate with the verified user generating the broadcast through the work-opportunity listing server,
wherein any private neighborhood community in which the verified user has a non-transitory connection is at least one of a residential address of the verified user and a work address of the verified user that has been confirmed by the work-opportunity listing server as being associated with the verified user, and
wherein the threshold distance is between 0.2 and 0.4 miles from the set of geospatial coordinates associated with the job broadcast data generated through the mobile device to optimize a relevancy of the live-broadcast,
wherein the work-opportunity listing server includes a crowdsourced moderation algorithm in which multiple neighbors to a geospatial area determine what content contributed to the work-opportunity listing server persists and which is deleted, and
wherein the work-opportunity listing server permits users to mute messages of specific verified users to prevent misuse of the work-opportunity listing server.

11. A method of a work-opportunity listing server comprising:
determining that a time stamp associated with a creation date and a creation time of a job broadcast data generated through a computing device is trusted based on a claimed geospatial location of a user of the work-opportunity listing server using a processor and a memory; and
automatically publishing the job broadcast data generated through the computing device on a set of user profiles having associated verified addresses in a threshold radial distance from a set of geospatial coordinates associated with the job broadcast data generated through the computing device of the user of the work-opportunity listing server using a radial algorithm; and
radially distributing the job broadcast data as a notification data through at least one of an on-page posting, an electronic communication, and a push notification delivered to at least one of:
a set of recipients 114 through an internet protocol (IP) based network associated with users and their user profiles around an epicenter defined at the set of geo spatial coordinates associated with the job broadcast data generated through the computing device, and
a set of service providers accessible by the work opportunity server through a cellular network using the radial algorithm in addition to the set of recipients 114 through the IP based network associated with users and their user profiles.
to all subscribed user profiles in a circular geo-fenced area defined by the threshold distance from the set of geospatial coordinates associated with the job broadcast data generated through the computing device through the radial algorithm of a neighborhood broadcasting system that measures a distance away of each address associated with each user profile from the current geospatial location at the epicenter.

12. The method of claim 11 further comprising:
validating that the job broadcast data generated through the computing device is associated with the user of the work-opportunity listing server;
verifying that the set of geospatial coordinates associated with the job broadcast data generated through the computing device are trusted based on the claimed geospatial location of the user of the work-opportunity listing server;
processing at least one of a listing criteria associated with the job broadcast data comprising a description, a photograph, a video, a salary, a fixed fee amount, an category, a functional status of a job offered through the job broadcast data, wherein the job is at least one of a household job, a repair job, a maintenance job, a professional job and a career opportunity;
populating an availability chart when the job associated with the listing criteria is posted, wherein the availability chart includes at least one of an target candidate living area radius, a start timing, an hours per day, an hours per month, a professional qualification criteria and a timing criteria;
determining that the broadcast data is generated by the user of the neighborhood broadcast system when validating that the broadcast data is associated with the computing device;
determining that an application on the computing device is communicating the broadcast data to the neighborhood broadcasting system when the broadcast data is processed; and
associating the user with a user profile in the neighborhood broadcasting system through the application on the computing device; and
presenting the job broadcast data generated through the computing device as a job alert pushpin of the job broadcast in a geospatial map surrounding pre-populated residential and business listings in a surrounding vicinity, such that the job alert pushpin of the job broadcast is automatically presented on the geospatial map in addition to being presented on the set of user profiles having associated verified addresses in the threshold radial distance from the set of geospatial coordinates associated with the job broadcast data generated through the computing device of the user of the work-opportunity listing server,

13. The method of claim 12 further comprising:
permitting the user to drag and drop the job alert pushpin on any location on the geospatial map, and automatically determining a latitude and a longitude associated a placed location;
automatically notifying at least one of a career center, a hardware store, a professional services provider, a landscaper, a gardener, a plumber, a handyman, and a homeless shelter in a surrounding geospatial area to the set of geospatial coordinates associated with the job broadcast data generated through the computing device.

14. A system comprising:
a work opportunity server to automatically publish a job broadcast data on a set of user profiles having associated verified addresses in a threshold radial distance from the set of geospatial coordinates associated with the job broadcast data of a verified user of the work-opportunity listing server using a radial algorithm;
a network; and
a mobile device communicatively coupled with the work opportunity server through the network to generate the job broadcast data using at least one of a camera, a microphone, and a sensory capability of the mobile device to generate a captured data that is appended with a present geospatial location and a time stamp associated with a creation date and a creation time of the captured data in generating the job broadcast data.

15. The system of claim 14 in which the work opportunity server further comprises:
a validation module to determine that a job broadcast data generated through a mobile device is associated with a verified user of the work-opportunity listing server using a processor and a memory, and to determine that the broadcast data is generated by the verified user of the neighborhood broadcast system when validating that the broadcast data is associated with the mobile device and to ensure that a set of geospatial coordinates associated with the job broadcast data generated through the mobile device are trusted based on a claimed geospatial location of the verified user of the work-opportunity listing server;
a time stamp module 202 to determine that a time stamp associated with a creation date and a creation time of the job broadcast data generated through the mobile device is trusted based on the claimed geospatial location of the verified user of the work-opportunity listing server;
a listing module to determine at least one of a listing criteria associated with the job broadcast data comprising a description, a photograph, a video, a salary, a fixed fee amount, an category, a functional status of a job offered through the job broadcast data, wherein the job is at least one of a household job, a repair job, a maintenance job, a professional job and a career opportunity;
a charting module to populate an availability chart when the job associated with the listing criteria is posted, wherein the availability chart includes at least one of an target candidate living area radius, a start timing, an hours per day, an hours per month, a professional qualification criteria and a timing criteria;
an application module to communicate the broadcast data to the neighborhood broadcasting system when the broadcast data is processed, and to associate the verified user with a verified user profile in the neighborhood broadcasting system through the application on the mobile device;
a pushpin module to present the job broadcast data generated through the mobile device as a job alert pushpin of the job broadcast in a geospatial map surrounding pre-populated residential and business listings in a surrounding vicinity, such that the job alert pushpin of the job broadcast is automatically presented on the geospatial map in addition to being presented on the set of user profiles having associated verified addresses in the threshold radial distance from the set of geospatial coordinates associated with the job broadcast data generated through the mobile device of the verified user of the work-opportunity listing server; and
a radial distribution module to radially distribute the job broadcast data generated through the mobile device through at least one of an on-page posting, an electronic communication, and a push notification delivered to desktop and mobile devices associated with users and their user profiles around an epicenter defined at the set of geospatial coordinates associated with the job broadcast data generated through the mobile device to all subscribed user profiles in a circular geo-fenced area defined by the threshold distance from the set of geospatial coordinates associated with the job broadcast data generated through the mobile device through the radial algorithm of a neighborhood broadcasting system that measures a distance away of each address associated with each user profile from the current geospatial location at the epicenter.

16. The system of claim 15 in which the work opportunity server further comprises:
a placement module to enable the verified user to drag and drop the job alert pushpin on any location on the geospatial map, and automatically determining a latitude and a longitude associated a placed location; and
a notification module to automatically notifying at least one of a career center, a hardware store, a professional services provider, a landscaper, a gardener, a plumber, a handyman, and a homeless shelter in a surrounding geospatial area to the set of geospatial coordinates associated with the job broadcast data generated through the mobile device.

17. The system of claim 16 in which the work opportunity server further comprises:
an extraction module to separate the geospatial coordinates from a metadata associated with the job broadcast data generated through the mobile device when verifying that the set of geospatial coordinates associated with the job broadcast data generated through the mobile device are trusted based on the claimed geospatial location of the verified user of the work-opportunity listing server.

18. The system of claim 17 in which the work opportunity server further comprises:
a matching module to determine a relative match between a persistent clock associated with the work-opportunity listing server and a digital clock of the mobile device to determine that the time stamp associated with the creation date and time of the job broadcast data generated through the mobile device is accurate and therefore trusted; and
a deletion module automatically remove the a publishing the job broadcast data generated through the mobile device on a set of user profiles having associated verified addresses in the threshold radial distance from the set of geospatial coordinates associated with the job broadcast data generated through the mobile device of the verified user of the work-opportunity listing server based on a job alert expiration time.

19. The method of claim 18 in which the work opportunity server further comprises:
a plotting module to geocode a set of residential addresses each associated with a resident name in a neighborhood surrounding the mobile device; and
a data-seeding module to prepopulate the set of residential addresses each associated with the resident name as the set of user profiles in the threshold radial distance from the claimed geospatial location of the verified user of the work-opportunity listing server in a neighborhood curation system communicatively coupled with the work-opportunity listing server.

20. The system of claim 19 in which the work opportunity server further comprises:
modification module to alter content in each of the set of user profiles;
discovery module to track the modified content through the neighborhood curation system;
an undo module to generate a reversible history journal associated with each of the set of user profiles such that a modification of the verified user can be undone on a modified user profile page;
a reputation module to determine an editing credibility of the verified user based on an edit history of the verified user and a community contribution validation of the verified user by other users of the neighborhood curation system;
a publishing module to automatically communicate the job broadcast data generated through the mobile device to a set of user profiles having associated verified addresses in a threshold radial distance from the claimed geospatial location of the verified user of the work-opportunity listing server using the radial algorithm;
a claiming module to process a claim request of the verified user generating the job broadcast data generated through the mobile device through the mobile device to be associated with an address of the neighborhood curation system;
a private-neighborhood module to determine if the claimable neighborhood in the neighborhood curation system is associated with a private neighborhood community in the claimable neighborhood of the neighborhood curation system;
an association module to associate the verified user with the private neighborhood community in the claimable neighborhood of the neighborhood curation system if the private neighborhood community has been activated by at least one of the verified user and a different verified user;
a boundary module to permit the verified user to draw a set of boundary lines in a form of a geospatial polygon such that the claimable neighborhood in a geospatial region surrounding the claim request creates the private neighborhood community in the neighborhood curation system if the private neighborhood community is inactive;
an address type module to verify the claim request of the verified user generating the job broadcast data generated through the mobile device through the mobile device to be associated with a neighborhood address of the neighborhood curation system when the address is determined to be associated with at least one of a work address and a residential address of the verified user;
a concurrency module to simultaneously publish the job broadcast data generated through the mobile device on the private neighborhood community associated with the verified user generating the job broadcast data generated through the mobile device through the mobile device in the threshold radial distance from the address associated with the claim request of the verified user of the neighborhood curation system when automatically publishing the job broadcast data generated through the mobile device on a set of user profiles having associated verified addresses in a threshold radial distance from the claimed geospatial location of the verified user of the work-opportunity listing server based on a set of preferences of the verified user using the radial algorithm;
a download module to automatically download a set of resumes to the mobile device, wherein an employer is the verified user, and to provide an interface to the employer such that the employer can use a haptic ‘flick’ gesture in at least one of a horizontal and a vertical fashion to switch a viewing pane associated with a resume;
an employer module to analyze a response of the employer being at least one a dismiss, a save, a rating, a review and an interview of an applicant for the job associated with the job broadcast data through the work-opportunity listing server and to automatically initiate at least one of a video communication and an audio communication between the mobile device of the employer and another mobile device the potential job applicant through the work-opportunity listing server based on the interview of the applicant for the job associated with the job broadcast data through the work-opportunity listing server;
an applicant module to permit the job applicant and other job applicants to view at least one of the rating and the review provided by the employer for each of the potential job applicants based on a participation criteria set by at least one of the employer and the job applicant, such that each job applicant is able to view ratings and reviews of each participating candidate for the job associated with the job broadcast data, and to permit each job applicant for the job associated with the job broadcast data to communicate with each other and form social connections with each other based on the participation criteria set by at least one of the employer and the job applicant, such that each job applicant is able to form social connections with each participating candidate for the job associated with the job broadcast data;
a historical applicant module to permit participating employers in the work-opportunity listing server to see at least one of previous ratings, interview comments, reviews, prescreen questions, and background checks of across a plurality of applicants applying for a plurality jobs through the work-opportunity listing server such that different employers benefit from previous diligence of at one of previous ratings, interview comments, reviews, prescreen questions, and background checks by participating employers with each applicant to the job that has previously applied for different jobs through the work-opportunity listing server;
a summary module to generate a summary data to the employer generating the job broadcast data generated through the mobile device through the mobile device of how many user profile pages were updated with an alert of the job broadcast data generated through the mobile device when publishing the job broadcast data generated through the mobile device in at least one of the private neighborhood community and the set of user profiles having associated verified addresses in the threshold radial distance from the claimed geospatial location of the verified user of the work-opportunity listing server based on the set of preferences of the verified user;
a live broadcast module to live broadcasting the job broadcast data generated through the mobile device to the different verified user and other verified users in at least one of the private neighborhood community and currently within the threshold radial distance from the current geospatial location through the work-opportunity listing server through a multicast algorithm such that a live broadcast multicasts to a plurality of data processing systems associated with each of the different user and the other verified users simultaneously when the mobile device of the verified user generating the live-broadcast enables broadcasting of the job broadcast data generated through the mobile device to any one of a geospatial vicinity around the mobile device of the verified user generating the broadcast and in any private neighborhood community in which the verified user has a non-transitory connection;
a bi-directional communication module to permit the different verified user and other verified users in at least one of the private neighborhood community to bi-directionally communicate with the verified user generating the broadcast through the work-opportunity listing server;
a moderation module to apply a crowdsourced moderation algorithm in which multiple neighbors to a geospatial area determine what content contributed to the work-opportunity listing server persists and which is deleted;
a muting module to permit users to mute messages of specific verified users to prevent misuse of the work-opportunity listing server;
a threshold module to automatically set the threshold distance between 0.2 and 0.4 miles from the set of geospatial coordinates associated with the job broadcast data generated through the mobile device to optimize a relevancy of the live-broadcast; and
a non-transitory module determine any private neighborhood community in which the verified user has a non-transitory connection is at least one of a residential address of the verified user and a work address of the verified user that has been confirmed by the work-opportunity listing server as being associated with the verified user.
